(19) United States
(12) Patent Application Publication
(10) Pub. No.: US 2018/0067680 A1
(43) Pub. Date: Mar. 8, 2018

(54) STORAGE CONTROL APPARATUS, SYSTEM, AND STORAGE MEDIUM

(71) Applicant: Fujitsu Limited, Kawasaki-shi (JP)

(72) Inventor: HIROKI OHTSUJI, Yokohama (JP)

(73) Assignee: Fujitsu Limited, Kawasaki-shi (JP)

(21) Appl. No.: 15/684,989

(22) Filed: Aug. 24, 2017

(30) Foreign Application Priority Data
Sep. 7, 2016 (JP) 2016-174565

(51) Int. Cl. G06F 3/06; G06F 17/30; G06F 12/02

(52) U.S. Cl. CPC G06F 3/0641; G06F 17/30159; G06F 3/0683; G06F 3/0604; G06F 3/0614; G06F 12/0246

(57) ABSTRACT

A storage control apparatus is configured to: detect a ratio of a number of first data blocks stored by a first process including executing deduplication to a number of second data blocks stored by a second process not including executing the deduplication in data blocks stored in a storage device, and determine which of the first and second processes to use to execute a write process for a third write data block which is newly requested to be written so that the ratio approaches a target ratio based on a load of a third process for the second data blocks and a lower limit target value of a number of write requests processable per unit time in response to write requests, the third process including executing the deduplication for each of the second data blocks and storing again the second data block in any storage device.

### CROSS-REFERENCE IO RELATED APPLICATION

This application is based upon and claims the benefit of priority of the prior Japanese Patent Application No. 2016-174565, filed on Sep. 7, 2016, the entire contents of which are incorporated herein by reference.

### FIELD

The embodiments discussed herein are related to a storage control apparatus, a system, and a storage medium.

### BACKGROUND

One of known techniques for storage systems is “deduplication” for efficiently using a storage area of a storage device by avoiding storing duplicate data in the storage device. The deduplication technique includes inline deduplication and post-process deduplication. The inline deduplication includes storing data requested to be written in a storage device after duplication for the data block, and responding to the write request. The post-process deduplication includes: first storing data requested to be written in a storage device temporarily and responding; and then executing deduplication in the stored data at a later time.

Moreover, storage systems may use both of the inline deduplication and the post-process deduplication. For example, a storage system is proposed, which executes inline deduplication on a file basis under a predetermined condition and then executes post-process deduplication on a chunk basis for files with no duplicates removed. Another proposed storage device selectively applies one of inline deduplication and post-process deduplication so that the total size of data to be processed by the inline deduplication is balanced with the total size of data to be processed by the post-process deduplication. Here, this storage device employs the method of balancing the two total sizes for the purpose of reducing the capacity of the temporary storage device for the data to be processed by the post-process deduplication.

The conventional techniques are disclosed in International Publication Pamphlet No. WO 2013/157103 and Japanese National Publication of International Patent Application No. 2015-528928, for example.

### SUMMARY

According to an aspect of the invention, a storage control apparatus configured to control operation of a storage system including a plurality of storage nodes, each of the plurality of storage nodes including a storage device, the storage control apparatus includes: a memory; and a processor coupled to the memory and configured to: detect a ratio of a number of first data blocks stored by a first process to a number of second data blocks stored by a second process in data blocks stored in at least one of the storage devices included in the plurality of storage nodes, the first process including: from one of the plurality of storage nodes which has received a request to write a first write data block from a host apparatus, storing the first write data block in the storage device of any one of the plurality of storage nodes as one of the first data blocks after executing deduplication, and responding to the host apparatus with regard to the storing, the second process including: from one of the plurality of storage nodes which has received a request to write a second write data block from the host apparatus, storing the second write data block in the storage device of any one of the plurality of storage nodes as one of the second data blocks without executing the deduplication, and responding to the host apparatus with regard to the storing, and determine which of the first and second processes to use to execute a write process for a third write data block which is newly requested to be written from the host apparatus so that the ratio approaches a target ratio based on a load of a third process for the second data blocks and a lower limit target value of a number of write requests processable per unit time in response to the write requests from the host apparatus, the third process including executing the deduplication for each of the second data blocks and storing again the second data block in the storage device of any one of the plurality of storage nodes.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 illustrates a configuration example and a processing example of a storage system according to a first embodiment;

FIG. 2 illustrates a configuration example of a storage system according to a second embodiment;

FIG. 3 illustrates a hardware configuration example of each server;

FIG. 4 illustrates caches and main table information included in the servers;

FIG. 5 illustrates a data configuration example of a hash management table;

FIG. 6 illustrates a data configuration example of an LBA management table;

FIG. 7 is a sequence diagram illustrating a basic procedure of a write control process in inline mode;

FIG. 8 illustrates a table updating process example in the inline mode;

FIG. 9 is a sequence diagram illustrating the basic procedure of a write control process in post-process mode;

FIG. 10 illustrates a table updating process example in the post-process mode;

FIG. 11 is a sequence diagram illustrating the procedure of a read control process in the storage system;

FIG. 12 illustrates a configuration example of processing functions included in the server;

FIG. 13 is a diagram for explaining a process to determine the write control mode;

FIG. 14 is a flowchart illustrating a procedure example of a write response process;

FIG. 15 is a flowchart illustrating a procedure example of a mode determination process;

FIG. 16 is a flowchart illustrating a procedure example of an IO control process in the inline mode;

FIG. 17 is a flowchart illustrating a procedure example of an IO control process in the post-process mode;

FIG. 18 is a flowchart illustrating a procedure example of a deduplication process.

FIG. 19 illustrates a procedure example of an LBA management process in the inline mode;

FIG. 20 illustrates a procedure example of the LBA management process in the post-process mode;

FIG. 21 is a flowchart illustrating a procedure example of a block rearrangement process in the background; and

FIG. 22 is a flowchart illustrating a procedure example of a destaging process.

### DESCRIPTION OF EMBODIMENTS

In the inline mode, deduplication is executed before the response to a write request is transmitted. The inline mode is therefore likely to take longer time to respond to a write request than the post-process mode in which deduplication is executed at a later time. On the other hand, in the post-process mode, the load of a series of processes including deduplication, which is executed at a later time, is likely to influence the performance of the process to respond to a write request. The load of the post process may reduce the maximum number of write requests that may be processed per unit time (IOPS: input/output per second).

In a storage system distributing and storing data in plural nodes, the following problems could reduce the IOPS. When such a storage system uses inline deduplication, data is transferred from the node having received a write request to another node in some cases. On the other hand, when the storage system uses post-process deduplication is used, data is transferred between nodes twice in some cases. At the first transfer, data is transferred from the node that has received the write request to the node that temporarily stores the data. At the second transfer, the data is transferred from the node having temporarily stored the data to another node that stores the deduplicated data. This is included in the post process.

In the post-process mode, data transfer between nodes is performed as the post process in some cases. The communication load of such data transfer between nodes could influence the performance of communication between the nodes to respond to the write request. The communication load of the post process could reduce the IOPS.

According to an aspect, an object of embodiments is to provide a technique which shortens the time taken to respond to a write request within a range that maintains the IOPS for write requests at a certain value or more.

Hereinafter, a description is given of the embodiments of the present disclosure with reference to the drawings.

### First Embodiment

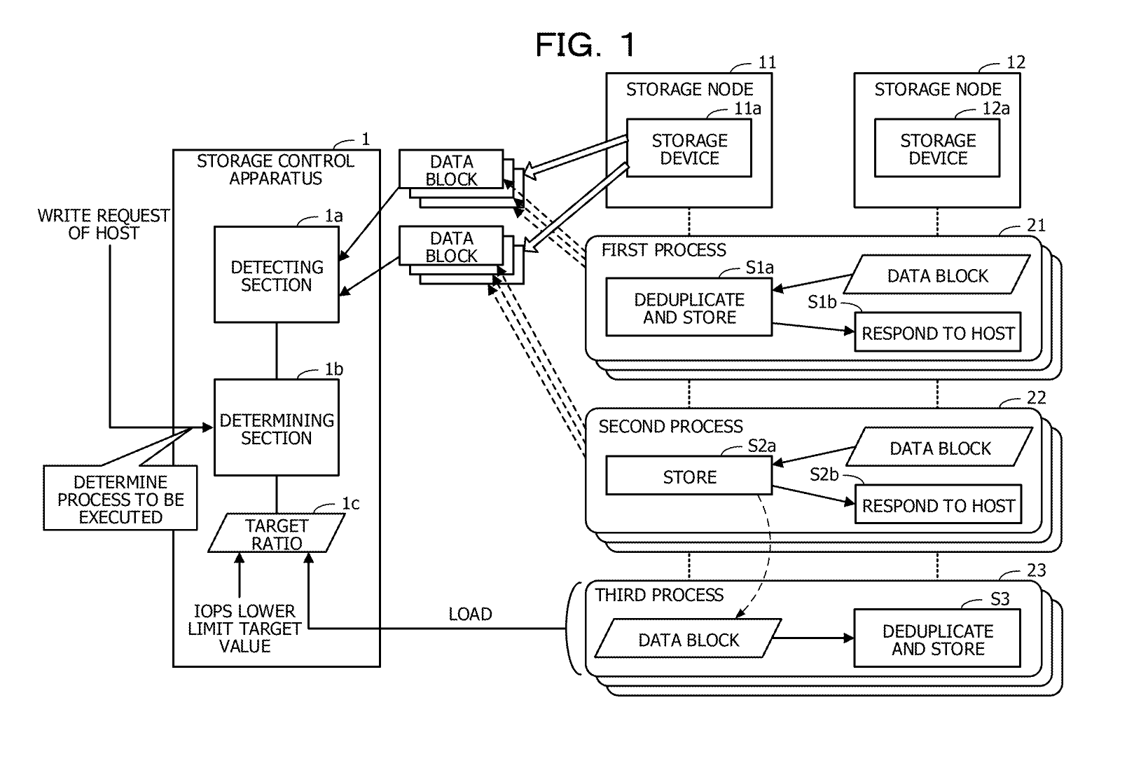

FIG. 1 illustrates a configuration example and a processing example of a storage system according to a first embodiment. The storage system illustrated in FIG. 1 includes plural storage nodes and a storage control apparatus 1. In the example of FIG. 1, the storage system includes two storage nodes 11 and 12. The number of storage nodes is not limited to two and may be three or more.

The storage node 11 includes a storage device 11a. The storage node 12 includes a storage device 12a. In the storage nodes 11 and 12, a data block requested by a not-illustrated host apparatus to be written is distributed and stored in the storage devices 11a and 12a.

The storage control apparatus 1 controls behaviors of the storage system. The storage control apparatus 1 includes a detecting section la and a determining section 1b. Processes of the detecting and determining sections 1a and 1b are implemented with a predetermined program executed by a processor which is provided for the storage control apparatus 1, for example. The storage control apparatus 1 may be included in one of the storage nodes 11 and 12.

The detecting section la detects the ratio of the number of data blocks stored by a first process 21 to the number of data blocks stored by a second process 22, among data blocks stored in at least one of the storage devices 11a and 12a. The detecting section la desirably detects the ratio of the number of data blocks stored by the first process 21 to the number of data blocks stored by the second process 22 among the data blocks stored in both of the storage devices 11a and 12a. When the target for detection is limited to a part of the plural storage devices, the detection process is simplified. The ratio in all the storage devices is estimated to a certain degree of accuracy.

The first process 21 includes a process to store a data block from a storage node (the storage node 12, for example) having received a request to write the data block from the host apparatus, in the storage device (the storage device 11a of the storage node 11, for example) of any one of the storage nodes 11 and 12 after duplication for the data block (step S1a) and a process to respond to the host apparatus (step S1b). The data blocks stored in the storage device by the first process 21 are therefore data deduplicated and stored in the storage devices.

The first process 21 may include calculation of hash values used in deduplication. The storage node in which each data block subjected to deduplication will be stored is determined so that data blocks are distributed and stored. For example, the storage node that will store each data block subjected to deduplication is determined based on the hash value calculated from the data block.

On the other hand, the second process 22 includes a process to store a data block from a storage node (the storage node 12, for example) having received a request to write the data block from the host apparatus, in the storage device (the storage device 11a of the storage node 11, for example) of any one of the storage nodes 11 and 12 without performing deduplication for the data block (step S2a) and a process to respond to the host apparatus (step S2b). The data blocks stored in the storage devices by the second process 22 are therefore data stored in the storage device without being deduplicated.

The storage node in which each data block will be stored by the second process 22 is determined so that the data blocks are distributed and stored. For example, the storage node in which each data block will be stored by the second process 22 is determined based on a logical address specified as the write destination.

The determining section 1b determines which of the first and second processes 21 and 22 will be used to execute a process to write a data block newly requested to be written by the host apparatus so that the ratio detected by the detecting section la approaches a target ratio 1c. The target ratio 1c is a value determined based on the load of the third process 23 for the data block stored in the storage device by the second process 22 and the lower limit target value of the IOPS (the maximum number of write requests processable per unit time in response to the write requests from the host apparatus).

The third process 23 includes a process to deduplicate the data blocks stored in the storage devices by the second process 22 and store the data blocks again in the storage device of any one of the storage nodes 11 and 12 (step S3). The third process 23 is post processing executed for data blocks stored in the storage devices by the second process 22 after response to the host apparatus.

The third process 23 may include calculation of hash values for use in deduplication. The storage node in which each data block will be stored by the third process 23 is determined so that the stored data blocks are distributed. For example, the storage node in which each data block will be stored by the third process 23 is determined based on the hash value calculated from the data block.

In the aforementioned first process 21, at executing step S1a, some data blocks are transferred from the storage node having received a write request to another storage node. Also in the aforementioned second process 22, at executing step S2a, some data blocks are transferred from the storage node having received a write request to anther storage node. Moreover, in the aforementioned third process 23, at executing step S3, some data blocks are transferred from the storage node in which the data blocks are stored by the second process 22 to anther storage node.

In comparison between the first and second processes 21 and 22, the time taken to respond to the host apparatus is shorter in the second process 22 because deduplication is not executed at storing the data block in the storage device. On the other hand, data blocks stored in the storage devices by the second process 22 are subjected to the third process 23 as the post processing. The third process 23 includes a process to deduplicate data blocks and store the data blocks again (step S3). During this process, some data blocks are transferred between the storage nodes as described above. Totally in the second and third processes 22 and 23, data blocks are transferred twice at maximum, and the amount of transferred data is likely to be larger than that of the first process 21. The second and third processes 22 and 23 influence on the communication load between the storage nodes more than the first process 21.

When the ratio of the number of executions of the second process 22 to that of the first and second processes 21 and 22 is increased in order to shorten the response time for the host apparatus, the amount of data transferred between the storage nodes could be increased. In such a case, the maximum number of communications per unit time between the storage nodes is reduced. Such reduction in the number of communications reduces the IOPS (the number of write requests from the host apparatus that may be processed per unit time).

As described above, the target ratio 1c is determined based on the load of the third process 23 and the lower limit target value of the IOPS. The IOPS may decrease as the number of executions of the third process 23 decreases and the number of data blocks transferred increases. The third process 23 is executed for the same number of times as the second process 22. In the light of the aforementioned relations, the target ratio 1c that maximizes the ratio of the number of executions the second process 22 to that of the first and second processes 21 and 22 is obtained so that the IOPS does not fall below the lower limit target value.

The determining section 1b makes a control so that the ratio of the number of executions of the first process 21 to that of the second process 22 approaches the target ratio 1c. The ratio of the number of executions of the second process 22 is therefore maximized with the IOPS being maintained to the lower limit target value or more. According to the storage control apparatus 1, the time taken to respond to a write request is shortened within a range that maintains the IOPS at a certain level or more.

### Second Embodiment

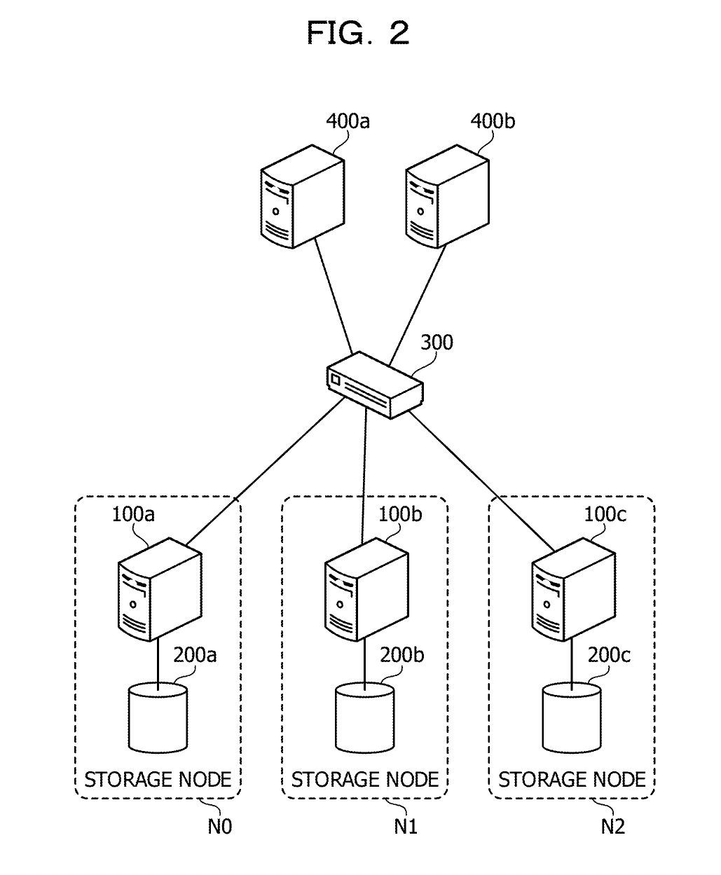

FIG. 2 illustrates a configuration example of a storage system according to a second embodiment. The storage system illustrated in FIG. 2 includes servers 100a to 100c, storages 200a to 200c, a switch 300, and host apparatuses 400a and 400b.

The servers 100a to 100c are coupled to the switch 300 and communicate with each other through the switch 300. The servers 100a to 100c are coupled to the storages 200a to 200c, respectively. The server 100a is a storage control apparatus controlling accesses to the storage 200a. Similarly, the servers 100b and 100c are storage control apparatuses controlling accesses to the storages 200b and 200c, respectively.

Each of the storages 200a to 200c includes one or plural non-volatile storage devices. In the second embodiment, each of the storages 200a to 200c includes plural solid state drives (SSDs).

The server 100a and storage 200a belong to a storage node N0; the server 100b and storage 200b, a storage node N1; and the server 100c and storage 200c, a storage node N2.

Each of the host apparatuses 400a and 400b is individually coupled to the switch 300 and communicates with at least one of the servers 100a to 100c through the switch 300. Each of the host apparatuses 400a and 400b transmits to at least one of the servers 100a to 100c, a request to access a logical volume provided by the servers 100a to 100c. The host apparatuses 400a and 400b are thus enabled to access the logical volume.

The relationship between the host apparatuses 400a and 400b and the servers 100a to 100c may be determined as follows, for example. The host apparatus 400a transmits a request to access a logical volume provided by the servers 100a to 100c, to the previously determined one of the servers 100a to 100c. The host apparatus 400b transmits a request to access another certain logical volume provided by the servers 100a to 100c, to another previously determined one of the servers 100a to 100c. The logical volumes are implemented by physical areas of the storages 200a to 200c.

The switch 300 relays data between the servers 100a to 100c and between the host apparatuses 400a and 400b and the servers 100a to 100c. The servers 100a to 100c are coupled to each other by InfiniBand (Trademark), and the host apparatuses 400a and 400b and servers 100a to 100c are also coupled to each other by InfiniBand (Trademark). Communication between the servers 100a to 100c and communication between the host apparatuses 400a and 400b and servers 100a to 100c may be individually performed through separate networks.

In the above-described configuration in FIG. 2, the three servers 100a to 100c are arranged. However, the storage system may include any number of servers not less than two. Moreover, FIG. 2 illustrates the configuration in which the two host apparatuses 400a and 400b are arranged. However, the storage system may include any number of host apparatus not less than one. In the configuration illustrated in FIG. 2, the servers 100a to 100c are coupled to the storages 200a to 200c, respectively. The servers 100a to 100c may be coupled to a common storage.

Hereinafter, the servers 100a to 100c are referred to as servers 100 in some cases if not distinguished in particular. The storages 200a to 200c are referred to as storages 200 in some cases if not distinguished in particular. The host apparatuses 400a and 400b are referred to as host apparatuses 400 in some cases if not distinguished in particular.

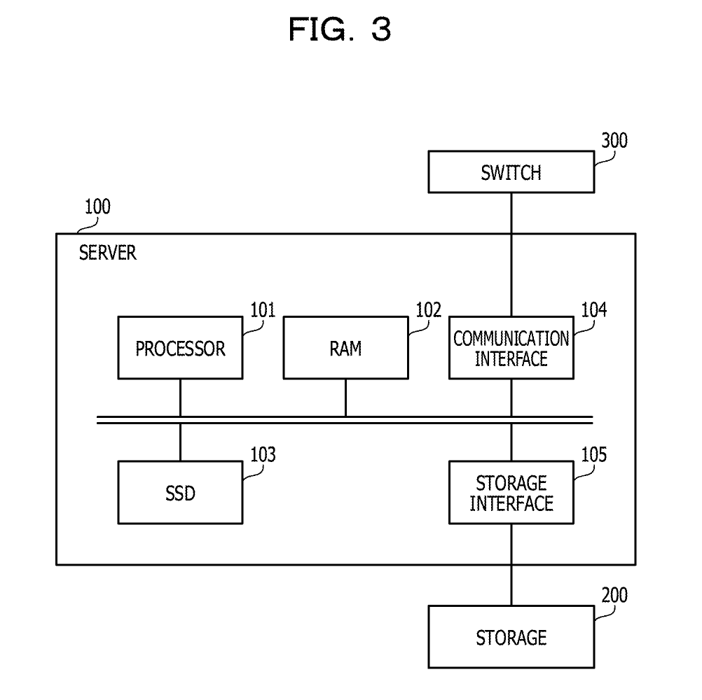

FIG. 3 illustrates a hardware configuration example of a server. The server 100 is implemented as a computer illustrated in FIG. 3, for example. The server 100 includes a processor 101, a random access memory (RAM) 102, an SSD 103, a communication interface 104, and a storage interface 105.

The processor 101 comprehensively controls processing of the server 100. The processor 101 is a central processing unit (CPU), a digital signal processor (DSP), an application specific integrated circuit (ASIC), or a field programmable gate array (FPGA), for example. The processor 101 may be a combination of two or more of CPUs, DSPs, ASICs, FPGAs, and the like.

The RAM 102 is used as a main storage device of the server 100. The RAM 102 temporarily stores at least some of the operation system (OS) and application programs to be executed by the processor 101. The RAM 102 also temporarily stores various types of data used in processing of the processor 101.

The SSD 103 is used as an auxiliary storage device of the server 100. The SSD 103 stores the OS program, application programs, and various types of data. The server 100 may include a hard disk drive (HDD) instead of the SSD 103 as the auxiliary storage device.

The communication interface 104 is an interface circuit for communication with another device through the switch 300. The storage interface 105 is an interface circuit for communication with the storage device mounted on the storage 200. The storage interface 105 and the storage device in the storage 200 communicate in accordance with a communication protocol, such as serial attached SCSI (SAS, SCSI: small computer system interface) or fibre channel (FC).

The processing functions of each server 100, that is, each server 100a to 100c, are implemented by the aforementioned configuration. Each of the host apparatuses 400a and 400b may be implemented as a computer illustrated in FIG. 3.

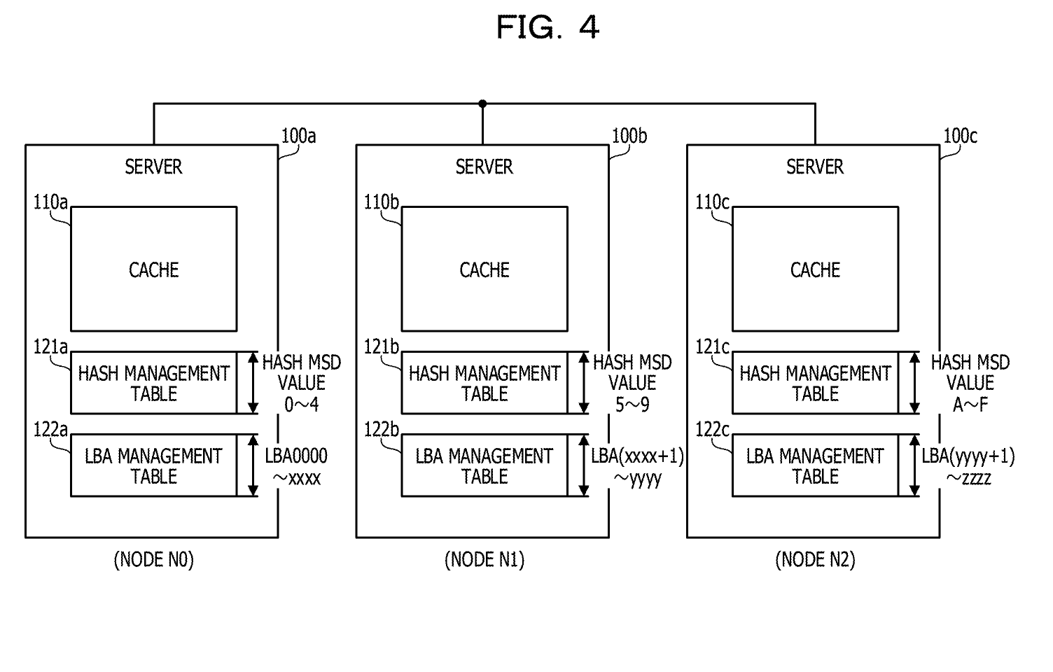

Next, a description is given of a storage control method in the servers 100a to 100c. FIG. 4 illustrates a cache and main table information included in each server. For simple description, the servers 100a to 100c are assumed to provide a logical volume implemented by physical areas of the storages 200a to 200c to the host apparatuses 400.

In the RAM 102 of the server 100a, an area for the cache 110a is reserved. Similarly, in the RAMs 102 of the servers 100b and 100c, areas for the caches 110b and 110c are reserved, respectively. In order to increase the response speed at reading data from the storage areas of the storages 200a to 200c corresponding to the logical volume, the caches 110a to 110c temporarily store data of the logical volume.

The storage system according to the second embodiment performs deduplication so that data with the same contents included in the logical volume is not stored redundantly in the storage areas. In deduplication, hash values (finger prints) of data to be written are calculated based on blocks of the logical volume, and data having the same hash values are not stored redundantly. Deduplication is performed not at the process of storing data in the storages 200a to 200c but at the process of storing data in the caches 110a to 110c.

The storage system distributes and manages data in the storage nodes N0 to N2 by using hash values as keys. Herein, the value at the most significant digit in each hash value expressed in hexadecimal is referred to as a hash MSD value. In the example of FIG. 4, data is distributed and managed based on the hash MSD value in the following manner.

The storage node N0 is in charge of managing data with a hash MSD value of 0 to 4. The storage 200a included in the storage node N0 stores only data with a hash MSD value of 0 to 4. The server 100a included in the storage node N0 holds a hash management table 121a in which the hash values with a hash MSD value of 0 to 4 are associated with respective positions where the corresponding data is stored.

The storage node N1 is in charge of managing data with a hash MSD value of 5 to 9. The storage 200b included in the storage node N1 stores only data with a hash MSD value of 5 to 9. The server 100b included in the storage node N1 holds a hash management table 121b in which the hash values with a hash MSD value of 5 to 9 are associated with respective positions where the corresponding data is stored.

The storage node N2 is in charge of managing data with a hash MSD value of A to F. The storage 200c included in the storage node N2 stores only data with a hash MSD value of A to F. The server 100c included in the storage node N2 holds a hash management table 121c in which the hash values with a hash MSD value of A to F are associated with respective positions where the corresponding data is stored.

According to the above-described distributed management, data within the logical volume is substantially equally distributed and stored in the storages 200a to 200c. Moreover, even if the frequencies of writing in respective blocks of the logical volume are unequal, write accesses to the storages 200a to 200c are substantially equally distributed. This reduces the maximum number of writes to each of the storages 200a to 200c. Moreover, by deduplication, data with the same contents is not written in the storages 200a to 200c, so that the number of writes in each of the storages 200a to 200c is further reduced.

Herein, SSDs are characterized by degrading in performance as the number of writes increases. The above-described distributed management reduces such degradation in performance of the SSDs and increases the life span of each SSD.

On the other hand, separately from the above-described distributed management based on the hash values, mapping of each block within the logical volume to a physical storage area is managed as follows. To each of the servers 100a to 100c, an area in charge of managing mapping to a physical storage area is assigned in the area of the logical volume. It is assumed that logical block addresses (LBA) of 0000 to zzzz are assigned to the blocks of the logical volume.

In the example of FIG. 4, the server 100a is in charge of mapping of blocks of LBA 0000 to LBA xxxx to physical storage areas and holds an LBA management table 122a for the mapping. The server 100b is in charge of mapping of blocks of LBA (xxxx+1) to LBA yyyy to physical storage areas and holds an LBA management table 122b for the mapping (xxxx<yyyy). The server 100c is in charge of mapping of blocks of LBA (yyyy+1) to LBA zzzz to physical storage areas and holds an LBA management table 122c for the mapping (yyyy<zzzz).

The mapping of each block to a physical storage area may be managed as follows, for example. The logical volume is divided into strips of a certain size (striping), and the strips are assigned sequentially to the servers 100a, 100b , 100c, 100a, 100b , . . . beginning with the first strip. Each of the servers 100a to 100c manages mapping of each block within the strip assigned to the server to a physical storage area.

Next, a description is given of a data configuration example of the hash management tables 121a to 121c and LBA management tables 122a to 122c. In the following description, the hash management tables 121a to 121c are referred to as hash management tables 121 in some cases if not distinguished in particular. The LBA management tables 122a to 122c are referred to as LBA management tables 122 in some cases if not distinguished in particular.

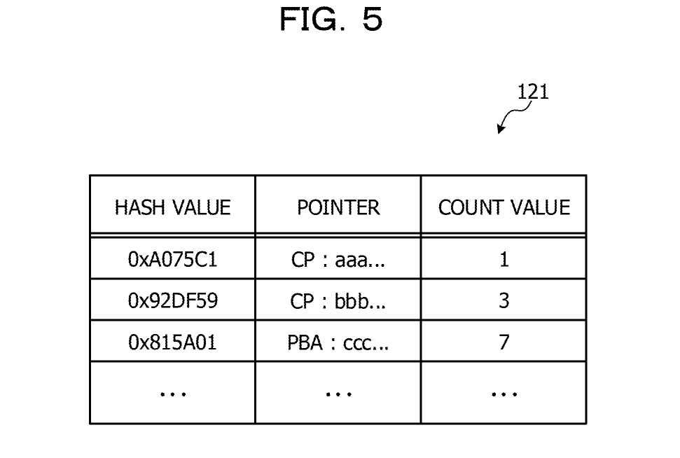

FIG. 5 illustrates a data configuration example of a hash management table. The hash management table 121 includes hash value, pointer, and count value fields. In the hash value fields, hash values calculated based on block-basis data are registered. In each pointer field, the pointer indicating the position at which corresponding data is stored is registered. When the data is in a cache, the page number of the cache page is registered in a pointer field. When the corresponding data is in a storage, an address on the storage (physical block address PBA) is registered in the pointer field. In FIG. 5, “CP:” indicates that the page number of a cache page is registered, and “PBA:” indicates that the PBA is registered. In each count value field, the number of LBAs which are associated with the storage position indicated by the corresponding pointer, that is, the value indicating how many redundant data blocks correspond to the hash number of interest.

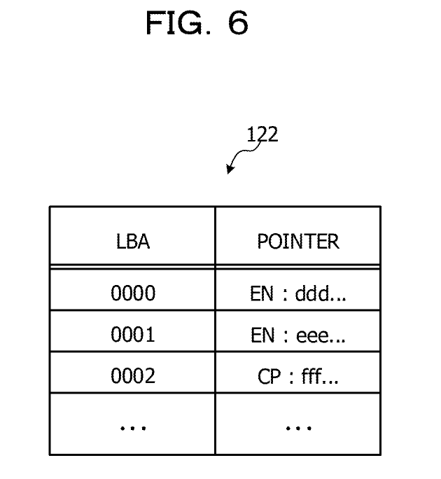

FIG. 6 illustrates a data configuration example of an LBA management table. The LBA management table 122 includes LBA and pointer fields. In each LBA field, an LBA indicating a block of the logical volume is registered. When the hash value of the corresponding data is already calculated, the address indicating the entry of the hash management table 121 is registered in each pointer field. When the hash value is not calculated, the page number of the corresponding cache page is registered in the pointer field. In FIG. 6, “EN:” indicates that the address of an entry is registered, and “CP:” indicates that the page number of a cache page is registered.

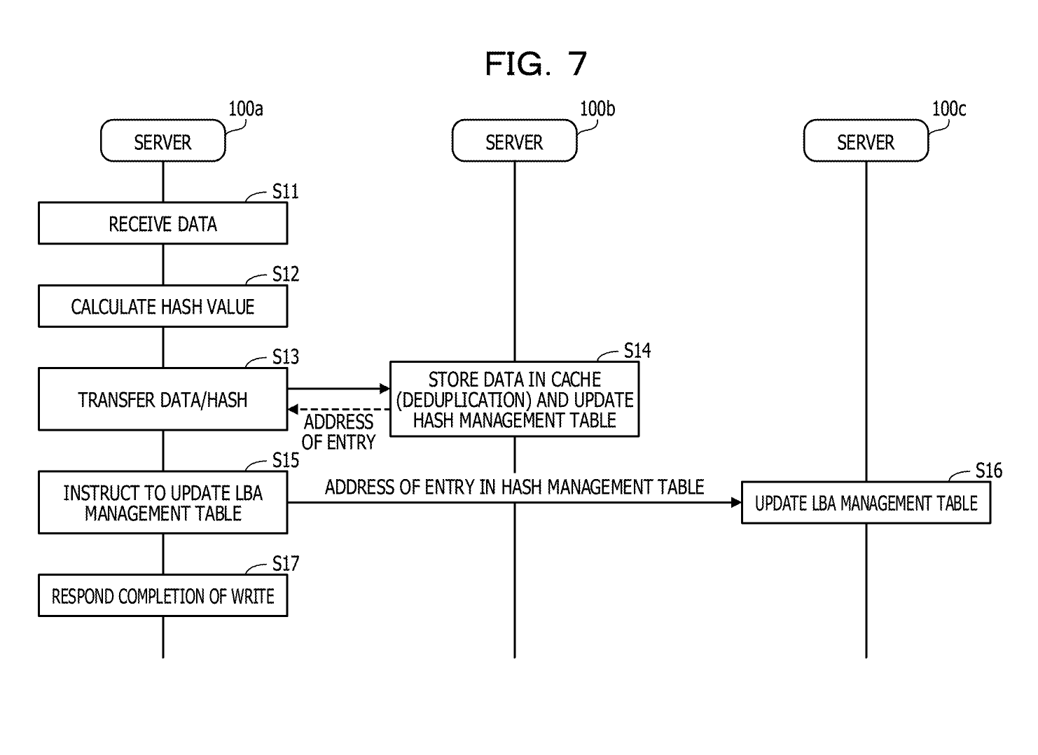

Next, a description is given of a basic write control process in the storage system using FIGS. 7 to 10. In the storage system, deduplication is performed not at the process of storing data in the storages 200a to 200c but at the process of storing data in the caches 110a to 110c as described above. As the method of deduplication, the inline method or post-process method is selectively used. In the inline method, deduplication is completed before response to the write request of the host apparatus 400. In the post-process method, deduplication is performed in the background after response to the write request of the host apparatus 400. Hereinafter, the write control mode using the inline method is referred to as an inline mode, and the write control mode using the post-process method is referred to as a post-process mode.

FIG. 7 is a sequence diagram illustrating a basic procedure of the write control process in the inline mode. In FIG. 7, the server 100a receives a request to write data from the host apparatus 400.

[Step S11] The server 100a receives data and a write request with an LBA of the logical volume specified as the write destination.

[Step S12] The server 100a calculates the hash value of the received data.

[Step S13] Based on the hash MSD value of the calculated hash value, the server 100a specifies the server that is in charge of managing data corresponding to the hash value. In the following description, the server that is in charge of managing data corresponding to a certain hash value is referred to as a server for the certain hash value in some cases. In the example of FIG. 7, the server 100b is specified as the server for the calculated hash value. In this case, the server 100a transfers the data and hash value to the server 100b and instructs the server 100b to write data.

[Step S14] The server 100b determines whether the received hash value is registered in the hash management table 121b.

When the received hash value is not registered in the hash management table 121b , the server 100b creates a new cache page in the cache 110b and stores the received data in the created cache page. The server 100b creates a new entry in the hash management table 121b and registers the received hash value, the page number of the created cache page, and a count value of 1 in the created entry. The server 100b transmits the address of the created entry to the server 100a.

On the other hand, when the received hash value is registered in the hash management table 121b, the data requested to be written is already stored in the cache 110b or storage 200b. In this case, the server 100b increments the count value in the entry where the hash value is registered and transmits the entry's address to the server 100a. The received data is discarded.

[Step S15] Based on the LBA specified as the write destination, the server 100a specifies the server that is in charge of mapping of the specified LBA to a physical storage area. In the following description, the server that is in charge of mapping of a certain LBA to a physical storage area is referred to as a server for the certain LBA in some cases. In the example of FIG. 7, the server 100c is specified as the server for the specified LBA. In this case, the server 100a transmits to the server 100c, the entry's address transmitted from the server 100b in the step S14 and the LBA specified as the write destination and instructs the server 100c to update the LBA management table 122c.

[Step S16] The server 100c registers the received entry's address in the pointer field of the entry in which the received LBA is registered, among the entries of the LBA management table 122c. This associates the block indicated by the LBA with the physical storage area.

[Step S17] Upon receiving a notice of completion of the table updating from the server 100c, the server 100a transmits a response message indicating write completion to the host apparatus 400.

As described above, in the inline mode, the data requested to be written is subjected to deduplication and stored in the cache of any one of the servers 100a to 100c before response to the host apparatus 400.

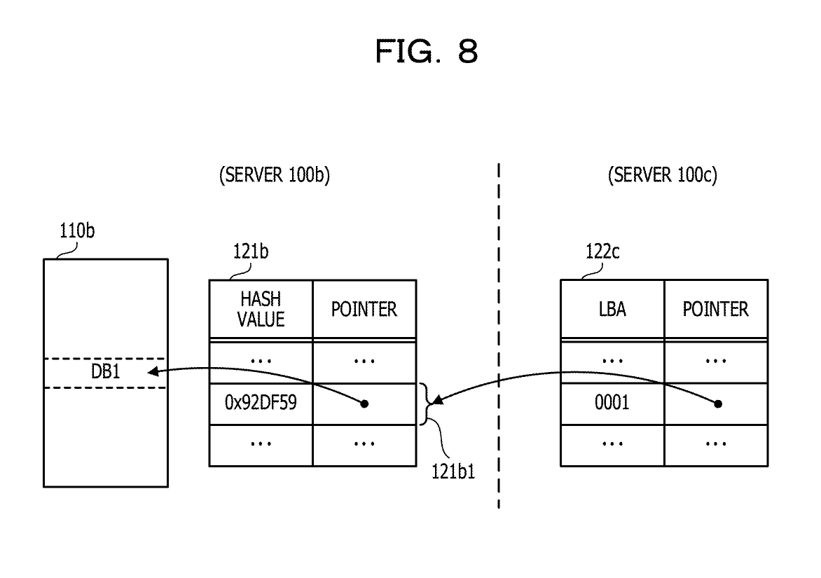

FIG. 8 illustrates a table updating process example of the inline mode. In FIG. 8, it is assumed that a request to write a data block DB1 in LBA 0001 is made in the process of FIG. 7. Based on the data block DB1, the hash value is calculated as 0×92DF59 (0× indicates a hexadecimal value).

In this case, by the process of the step S14, the data block DB1 is stored in the cache 110b of the server 100b. In entry 121b1 of the hash management table 121b held by the server 100b, information indicating a cache page storing the data DB1 is registered in a pointer field corresponding to the hash value “0×92DF59”. If a data block with the same contents as the data block DB1 is already registered in the cache 110b, the entry 121b1 including the aforementioned information is already registered in the hash management table 121b.

By the process of the step S16, in the LBA management table 122c held by the server 100c, information indicating the entry 121b1 of the hash management table 121b is registered in the pointer field corresponding to the LBA 0001.

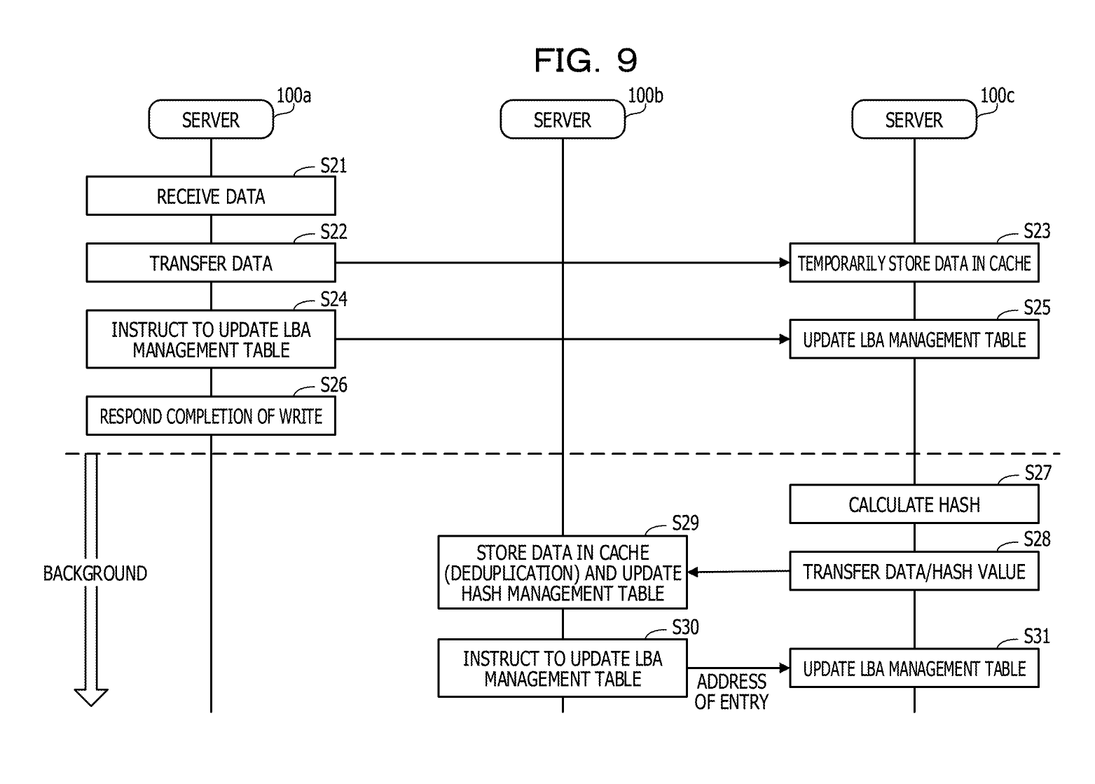

FIG. 9 is a sequence diagram illustrating a basic procedure of the write control process in the post-process mode. In FIG. 9, the server 100a receives a write request from the host apparatus 400 in a similar manner to FIG. 7, beginning with the same initial state as that of FIG. 7 by way of example.

[Step S21] The server 100a receives data and a write request with an LBA of the logical volume specified as the write destination.

[Step S22] Based on the LBA specified as the write destination, the server 100a specifies the server that is in charge of managing the correspondence relationship between the block as the write destination and the physical storage area. In the example of FIG. 9, the server 100c is specified as the server for the block as the write destination. In this case, the server 100a transmits the data requested to be written, to the server 100c and instructs the server 100c to store the data in the cache 110c.

[Step S23] The server 100c creates a new cache page in the cache 110c and stores the received data in the created cache page. The data is stored in the cache 110c as data of a hash uncalculated block which is not subjected to hash value calculation. The server 100c transmits the page number of the created cache page to the server 100a.

[Step S24] The server 100a transmits the received page number and the LBA specified as the write destination to the server 100c and instructs the server 100c to update the LBA management table 122c.

[Step S25] The server 100c registers the received page number in the pointer field of the entry in which the received LBA is registered, among the entries of the LBA management table 122c.

The LBA specified as the write destination may be transferred together with the data in the step S22. In this case, the communication between the servers 100a and 100c in the step S24 is unrequested.

[Step S26] Upon receiving a notice of completion of the table updating from the server 100c, the server 100a transmits a response message indicating write completion to the host apparatus 400.

[Step S27] The server 100c calculates the hash value of the data stored in the cache 110c in the step S23 asynchronously after the processing of the step S26.

[Step S28] Based on the hash MSD value of the calculated hash value, the server 100c specifies the server that is in charge of managing data corresponding to the calculated hash value. In the example of FIG. 9, the server 100b is specified as the server for the calculated hash value. In this case, the server 100c transfers the data and hash value to the server 100b and instructs the server 100b to write the data. The cache page storing the data is released.

[Step S29] The server 100b determines whether the received hash value is registered in the hash management table 121b. The server 100b then executes the process to store the data and update the hash management table 121b in accordance with the result of determination. The process is the same as that of the step S14 in FIG. 7.

[Step S30] The server 100b transmits the address of the entry of the hash management table 121b in which the received hash value is registered, to the server 100c and instructs the server 100c to update the LBA management table 122c.

[Step S31] The server 100c registers the received entry's address in the pointer field of the entry in which the LBA of the data subjected to hash value calculation in the step S27 is registered, among the entries of the LBA management table 122c. In the pointer field, the registered page number of the cache page is updated to the received entry's address.

As described above, in the post-process mode, the data requested to be written from the host apparatus 400 is once stored in the cache 120c of the server 100c, which is in charge of managing the LBA of the write destination, without determining the presence of duplicate data. When the process to store the data is completed and the process to update the LBA management table 122c due to the storing process is completed, the response massage is transmitted to the host apparatus 400. Not executing the deduplication process until the response as described above shortens the time (latency) taken to respond to the host apparatus 400 compared with the inline mode.

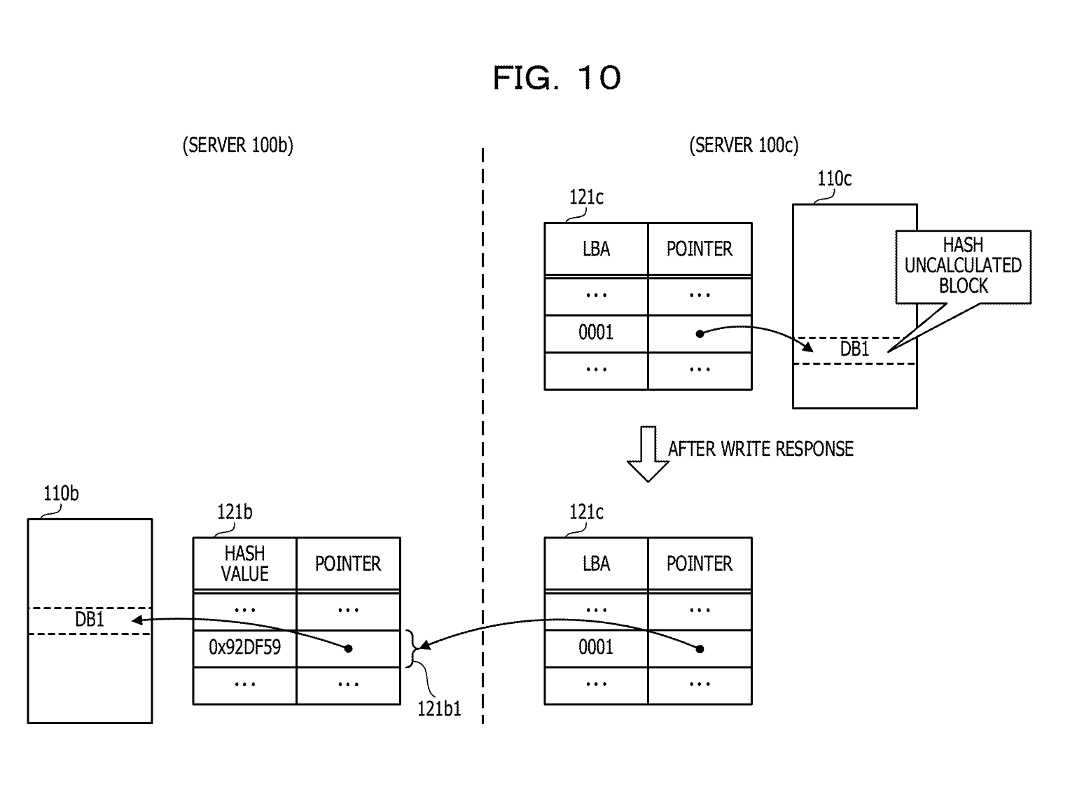

FIG. 10 illustrates a table updating process example in the post-process mode. In FIG. 10, it is assumed that a request to write a data block DB1 in LBA 0001 is made in the process of FIG. 9. Based on the data block DB1, the hash value is calculated as 0×92DF59.

In this case, the data block DB1 is stored in the cache 110c of the server 100c in the step S23 before response to the host apparatus 400. In the step S25, information indicating the data storage position in the cache 110c is registered in association with the LBA 0001 in the LBA management table 122c held by the server 100c.

In the step S28 after the response to the host apparatus 400, the data block DB1 is transferred to the server 100b, and the deduplication process is performed. In the step S29, the data block DB1 is stored in the cache 110b of the server 100b. In the entry 121b1 of the hash management table 121b held by the server 100b, information indicating the cache page storing the data block DB1 is registered in the pointer field corresponding to the hash value “0×92DF59”. When a data block with the same contents as the data block DB1 is already registered in the cache 110b, the entry 121b1 including the aforementioned information is already registered in the hash management table 121b.

In the step S31, information indicating the entry 121b1 of the hash management table 121b is registered in the pointer field corresponding to the LBA 0001 in the LBA management table 122c held by the server 100c.

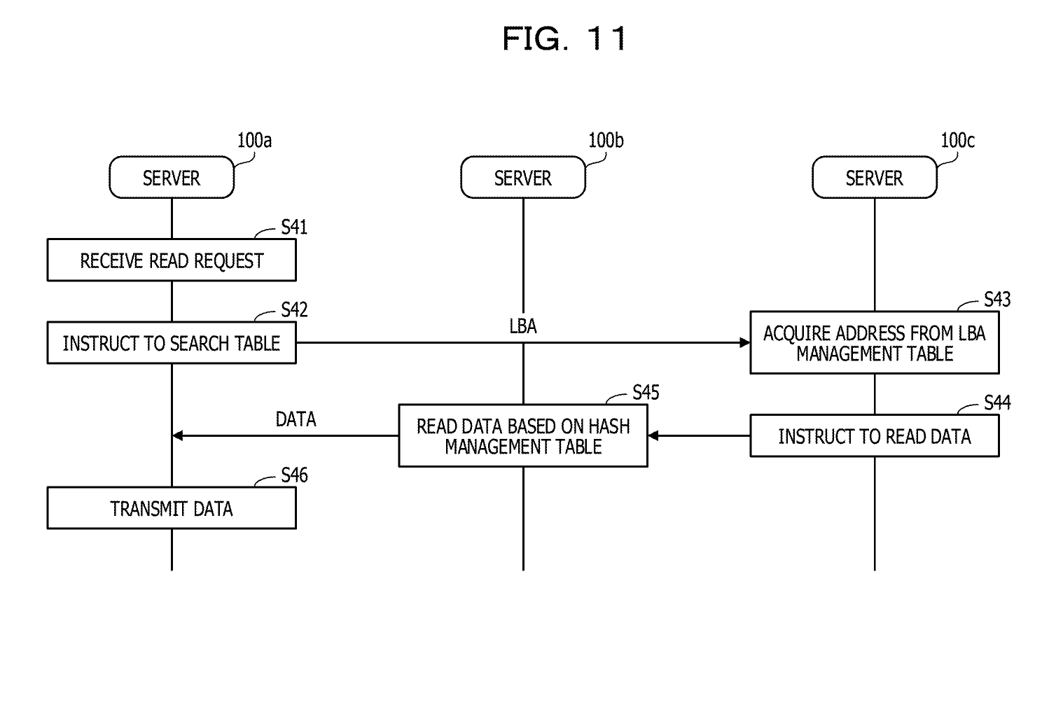

FIG. 11 is a sequence diagram illustrating the procedure of a read control process in the storage system. In FIG. 11, it is assumed that the host apparatus 400 requests the server 100a to read data from the LBA 0001.

[Step S41] The server 100a receives from the host apparatus 400, a request to read data from the LBA 0001.

[Step S42] Based on the LBA specified as the read source, the server 100a specifies the server that is in charge of managing the correspondence relationship between the read source block and a physical storage area. In the example of FIG. 11, the server 100c is specified as the server in charge of managing the correspondence relationship between the read source block and a physical storage area. In this case, the server 100a transmits the LBA to the server 100c and instructs the server 100c to search the LBA management table 122c.

[Step S43] The server 100c specifies the entry including the received LBA from the LBA management table 122c and acquires information from the pointer field of the specified entry. Herein, it is assumed that the server 100c acquires the address of the entry in the hash management table 121b of the server 100b from the pointer field.

[Step S44] The server 100c transmits the acquired entry's address to the server 100b and instructs the server 100b to read data from the corresponding storage area to the server 100a.

[Step S45] The server 100b refers to the entry indicated by the received address in the hash management table 121b and reads information from the pointer field. Herein, it is assumed that the server 100b reads the address of the cache page. The server 100b reads the data from the cache page of the cache 110b indicated by the read address and transmits the read data to the server 100a.

[Step S46] The server 100a transmits the received data to the host apparatus 400.

As described above, the data requested to be read is transmitted to the server 100a based on the hash management table 121 and LBA management table 122. In the step S43, the server 100c acquires the page number of the cache page of the cache 110c in the server 100c from the pointer field of the LBA management table 122c in some cases, for example. This occurs when the hash value of the data requested to be read is uncalculated. In this case, the server 100c reads data from the corresponding cache page of the cache 110c and transmits the data to the server 100a. The server 100a transmits the received data to the host apparatus 400.

As illustrated in FIG. 7, in the inline mode, the process to calculate a hash value is executed between the time that a write request is received from the host apparatus 400 and the time that the response to the host apparatus 400 is transmitted. It takes about 20 μs to calculate a hash value based on an 8 KB data block, for example. It accordingly takes long time to respond to the write request from the host apparatus 400.

On the other hand, as illustrated in FIG. 9, in the post-process mode, the process to calculate a hash value is not executed between the time that a write request is received from the host apparatus 400 and the time that the response to the host apparatus 400 is transmitted. Accordingly, the time taken to respond to the write request is shorter than that of the inline mode.

However, in the post-process mode, the process for deduplication including hash value calculation is executed in the background after the response is transmitted to the host apparatus 400. Accordingly, the processing load of each server in the background could reduce the IO response performance for the host apparatus 400.

Moreover, as illustrated in the example of FIG. 9, when the server temporarily holding data in a cache is different from the server that is specified based on the hash value and is in charge of managing the data in the background process, the servers communicate each other in the background process. The communication includes transfer of not only instructions, such as the table updating instruction, and responses thereto but also actual data to be written (see step S28 in FIG. 9).

As illustrated in the examples of FIGS. 7 and 9, communication between servers could occur between the time that a write request from the host apparatus 400 is received and the time that the response to the host apparatus 400 is transmitted both in the inline mode and the post-process mode. As illustrated in the example of FIG. 11, when a read request is received from the host apparatus 400, communication between servers could occur before the response to the host apparatus 400 is transmitted. Accordingly, if the communication traffic between servers is congested due to communication in the background process as described above, the IO response performance for the host apparatus 400 may degrade.

For example, there is an upper limit to the number of messages which are transmitted per unit time in communication between servers. As the number of communications between servers increases, the maximum number of IO requests of the host apparatus 400 that may be processed per unit time (the IOPS of the server 100 seen from the host apparatus 400) is reduced.

The server 100 of the second embodiment selectively executes the write control process in the inline mode or post-process mode and controls the ratio of the number of executions thereof. When the ratio of the number of executions of the write control process in the post-process mode is the higher, the response time (write response time) for a write request of the host apparatus 400 is shortened as a whole. However, the IOPS of the server 100 could be reduced because of the above reason.

In the second embodiment, the server 100 sets the target value of the IOPS. The server 100 controls the ratio of the number of executions of the write control process in the inline-mode to the post-process mode so that the write control process in the post-process mode is preferentially executed within a range that satisfies the target value. This shortens the response time for a write request while maintaining the IOPS of the server 100.

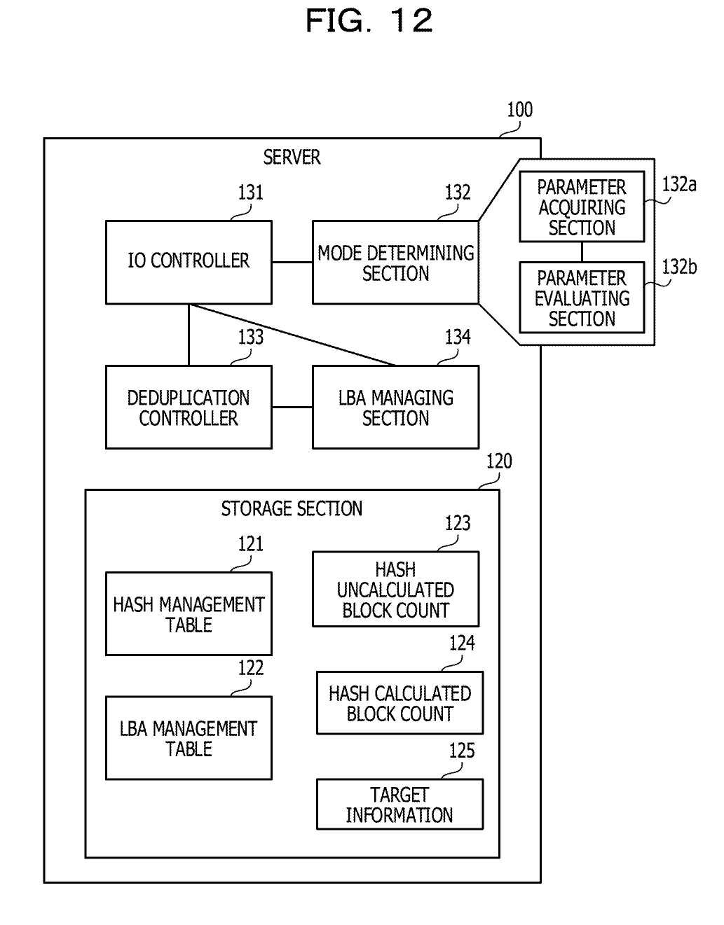

Next, a description is given of the process of each server 100 in detail. FIG. 12 illustrates a configuration example of processing functions included in a server 100. The server 100 includes a storage section 120, an IO controller 131, a mode determining section 132, a deduplication controller 133, and an LBA managing section 134.

The storage section 120 is implemented as a storage area of the storage device included in the server 100, such as the RAM 102 or SSD 103. The storage section 120 stores the above-described hash management table 121 and LBA management table 122. The storage section 120 further includes a hash uncalculated block count 123, a hash calculated block count 124, and target information 125.

The hash uncalculated block count 123 is a count value obtained by counting hash uncalculated blocks among data blocks stored in the cache 110 of the server 100. The hash uncalculated blocks are data blocks stored in the cache 110 of the server 100 for the LBA specified as the write destination by the host apparatus 400 without being subjected to hash value calculation of the write control process in the post-process mode.

The hash calculated block count 124 is a count value obtained by counting hash uncalculated blocks among data blocks stored in the cache 110 of the server 100. The hash calculated blocks are data blocks which are subjected to hash calculation and stored in the cache 110 of the server for the calculated hash value.

The target information 125 is information referred to for determining the write control mode. For example, the target information 125 includes the target value of the IOPS, including a performance target S, or a target ratio F_{tgt} as the target value of the ratio of the number of executions of the write control process of each mode. The information included in the target information 125 is described in detail later.

The processes of the IO controller 131, mode determining section 132, deduplication controller 133, and LBA managing section 134 are implemented with a predetermined program executed by the processor 101 included in the server 100, for example.

The IO controller 131 comprehensively controls the process to receive an IO request of the host apparatus 400 and respond to the received IO request. When receiving a write request of the host apparatus 400, the IO controller 131 inquires of the mode determining section 132 which of the inline and post-process modes will be selected as the write control mode.

When the inline mode is to be selected as the result of the inquiry, the IO controller 131 calculates the hash value of the data to be written and specifies the server for the calculated hash value. The IO controller 131 passes the data to be written and the calculated hash value to the deduplication controller 133 of the specified server for the calculated hash value and instructs the same server to store the data to be written and update the hash management table 121. The IO controller 131 then specifies the server for the LBA of the write destination. The IO controller 131 instructs the LBA managing section 134 of the specified server to update the LBA management table 122.

When the post-process mode is to be selected as the result of the inquiry, the IO controller 131 specifies the server for the LBA of the written destination. The IO controller 131 passes the data to be written to the LBA managing section 134 of the specified server and instructs the same server to store the data to be written and update the LBA management table 122.

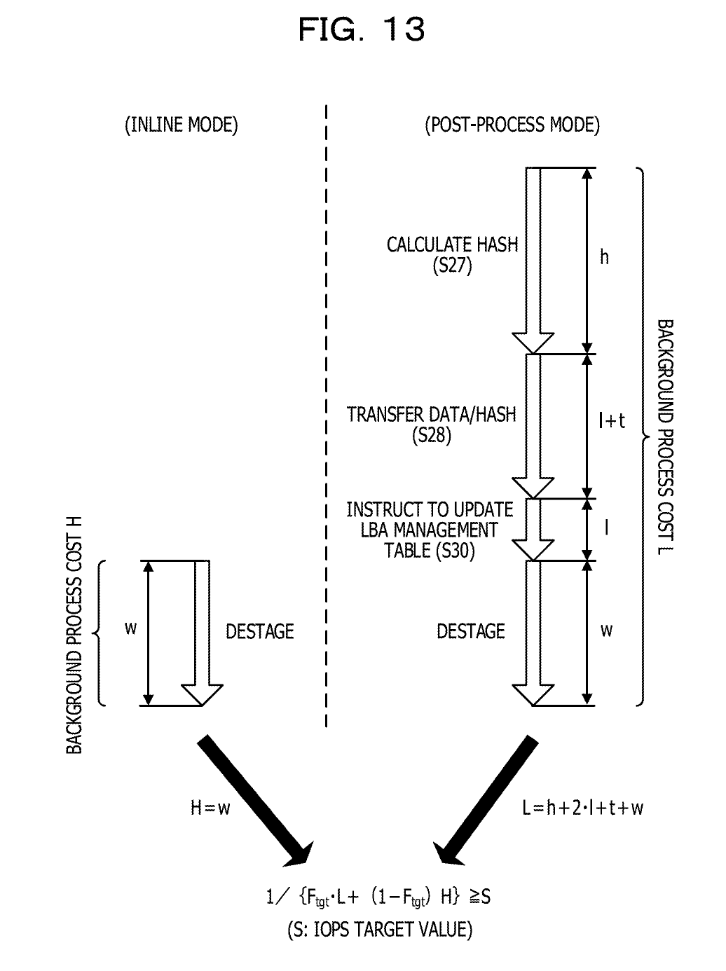

The mode determining section 132 determines which write control mode is to be selected, the inline-mode or post-process mode in response to the request from the IO controller 131. The mode determining section 132 includes a parameter acquiring section 132a and a parameter evaluating section 132b. The parameter acquiring section 132a acquires a parameter requested for determining the write control mode. The parameter evaluating section 132b evaluates the acquired parameter to determine the write control mode. The method of determining the write control mode by the mode determining section 132 is described in detail using FIG. 13 below.

When receiving the data to be written and the hash value, the deduplication controller 133 stores the data to be written in the cache 110 so that data with the same contents is not duplicated and updates the hash management table 121. In the write control process in the inline mode, the deduplication controller 133 receives the data to be written and the hash value from the IO controller 131 of any server 100. On the other hand, in the write control process in the post-process mode, the deduplication controller 133 receives the data to be written and the hash value from the LBA managing section 134 of any server 100 and instructs the LBA management section 134 to update the LBA management table 122.

In the write control process in the inline mode, the LBA managing section 134 updates the LBA management table 122 in response to the instruction from the IO controller 131. On the other hand, in the write control process in the post-process mode, in response to the instruction from the IO controller 131, the LBA managing section 134 stores the data to be written in the cache 110 as the data of a hash uncalculated block and updates the LBA management table 122. Moreover, the LBA managing section 134 sequentially selects data of hash uncalculated blocks in the cache 110, calculates the hash values of the selected data, and specifies the server for each calculated hash value. The LBA management section 134 passes the data and hash value to the deduplication controller 133 of the specified server and instructs the specified server to store the data and update the hash management table 121. The LBA managing section 134 updates the LBA management table 122 in response to the instruction from the deduplication controller 133.

Next, a description is given of the process to determine the write control mode by the mode determining section 132. FIG. 13 is a diagram for explaining the process to determine the write control mode.

The mode determining section 132 calculates the cost of the background process constituting a part of the write control process in the inline or post-process mode. The background process is a process performed between the time that the response to the write request is transmitted to the host apparatus 400 and the time that the data in the cache 110 is destaged to the storage 200. The cost refers to an interval between successive executions of the background process for the respective blocks.

As illustrated in the left side of FIG. 13, the background process in the inline mode includes only destaging data in the cache 110 to the storage 200. The cost of destaging is represented as a storage instruction interval w indicating the interval in which a command instructing the SSD of the storage 200 to store data of one block is transmitted. Cost H of the background process in the inline mode is therefore equal to w.

As illustrated in the right side of FIG. 13, the background process in the post-process mode includes calculating a hash value, transferring data and the hash value, instructing the server 100 to update the LBA managing table 122, and destaging the data in the cache 110 to the storage 200. The calculating the hash value corresponds to the process of the step S27 in FIG. 9, and the cost thereof is expressed as a hash value calculation time h based on data of a block. The transferring data and hash value corresponds to the process of the step S28 in FIG. 9, and the cost thereof is expressed as the sum of a command transmission interval I, which indicates an interval in which a command is transmitted from one server 100 to another server 100, and data transfer time t taken to transfer data of one block. The instructing the server 100 to update the LBA management table 122 corresponds to the process of the step S30 in FIG. 9, and the cost thereof is represented as the command transmission interval I. The cost of destaging is expressed as the storage instruction interval w in a similar manner to the inline mode. Cost L of the background process in the post-process mode is therefore calculated as h+2.1+t+w.

The cost H of the background process in the inline mode represents an interval in which data of a hash calculated block is able to be destaged from the cache 110 to the storage 200. The cost L of the background process in the post-process mode represents an interval in which data of a hash uncalculated block is able to be destaged from the cache 110 to the storage 200.

On the other hand, the performance target S, which indicates the minimum number of data blocks that are able to be destaged to the storage 200 per unit time among the data blocks stored in the cache 110, is previously given and is recorded in the target information 125. The performance target S is considered as an index indicating the minimum number of new blocks that are able to be stored in the cache 110 per unit time in response to a write request of the host apparatus 400 when the cache 110 has no free space. The performance target S may be used as one of the minimum standards for the IOPS that are guaranteed by the server 100.

Herein, the ratio of the number of hash uncalculated blocks to the number of hash calculated blocks in the cache 110 is expressed as F/1-F (0<=F <=1). The relationship between the costs of the background processes and the performance target S is therefore expressed as the following formula (1):

1/(F·L+(1-F)·H)>=S (1)

The mode determining section 132 calculates such a ratio of the number of hash uncalculated blocks to the number of hash calculated blocks in the cache 110 that satisfies the performance target S. Herein, the ratio that satisfies the performance target S is referred to as a target ratio F_{tgt}. The target ratio F_{tgt} is calculated by the following formula (2). This formula (2) is to calculate the ratio F by making the right and left sides of the formula (1) equal to each other.

F_{tgt}=(1-S·H)/S·(L-H) (2)

The target ratio F_{tgt} indicates the maximum value of the ratio F of the hash uncalculated blocks within a range that satisfies the performance target S. When the ratio of the number of hash uncalculated blocks to the number of hash calculated blocks in the cache 110 is equal to the target ratio F_{tgt}, the number of data blocks processed in the post-process mode is maximized with the IOPS of the server 100 being maintained at the target value or more. Accordingly, the response time for a write request of the host apparatus 400 is minimized with the IOPS of the server 100 being maintained at the target value or more.

The mode determining section 132 detects the current numbers of hash uncalculated blocks and hash calculated blocks in the cache 110 and calculates the ratio F_{det} of the former to the latter. The mode determining section 132 determines which of the inline mode and post-process mode is to be used in write control for a data block requested to be written from the host apparatus 400 so that the ratio F_{det} approaches the target ratio F_{tgt}. Accordingly, the response time for a write request of the host apparatus 400 is minimized with the IOPS of the server 100 being maintained at the target value or more.

In the second embodiment, among the parameters illustrated in FIG. 13, the calculation time h, command transmission interval I, data transfer time t are fixed values and are previously registered in the target information 125. Only the storage instruction interval w is detected each time determining the write control mode. This is because the storage instruction interval w in the SSD is likely to change depending on the amount of data stored in the SSD. For example, all the parameters illustrated in FIG. 13 may be fixed values. In this case, the target ratio F_{tgt} is a fixed value that does not have to be calculated each time determining the write control mode and has to be registered in the target information 125 previously. The parameters which are likely to dynamically change among the parameters other than the storage instruction interval w may be detected each time determining the write control mode.

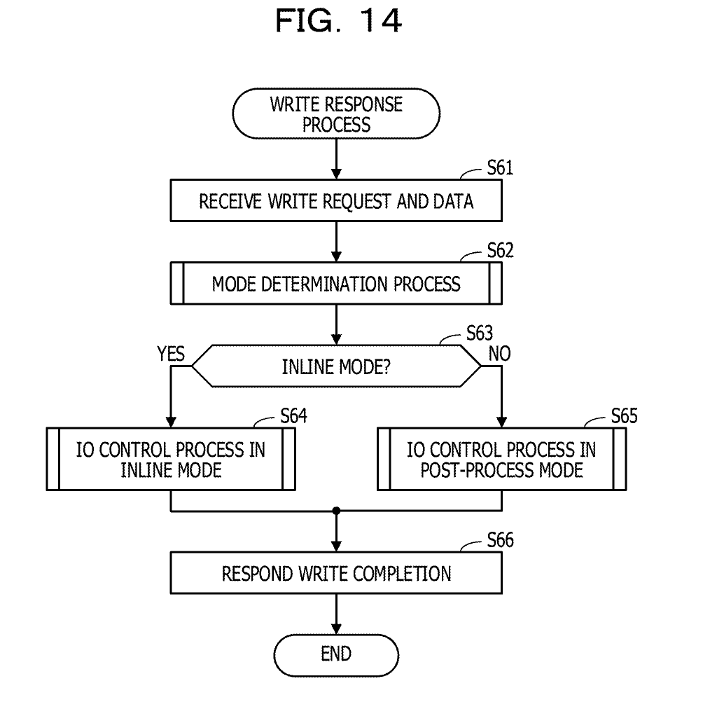

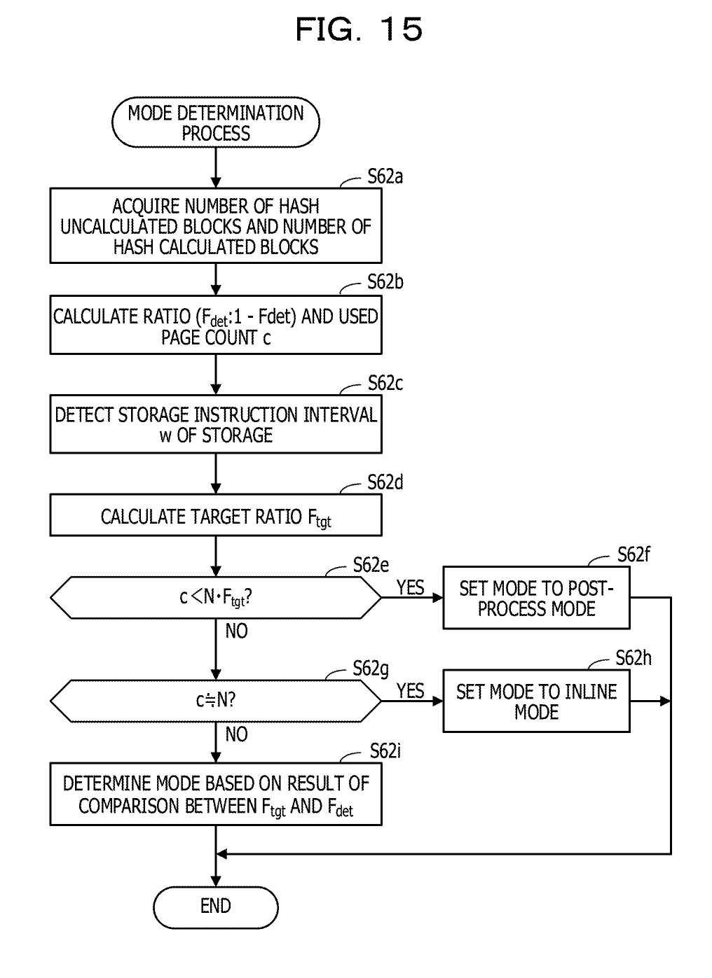

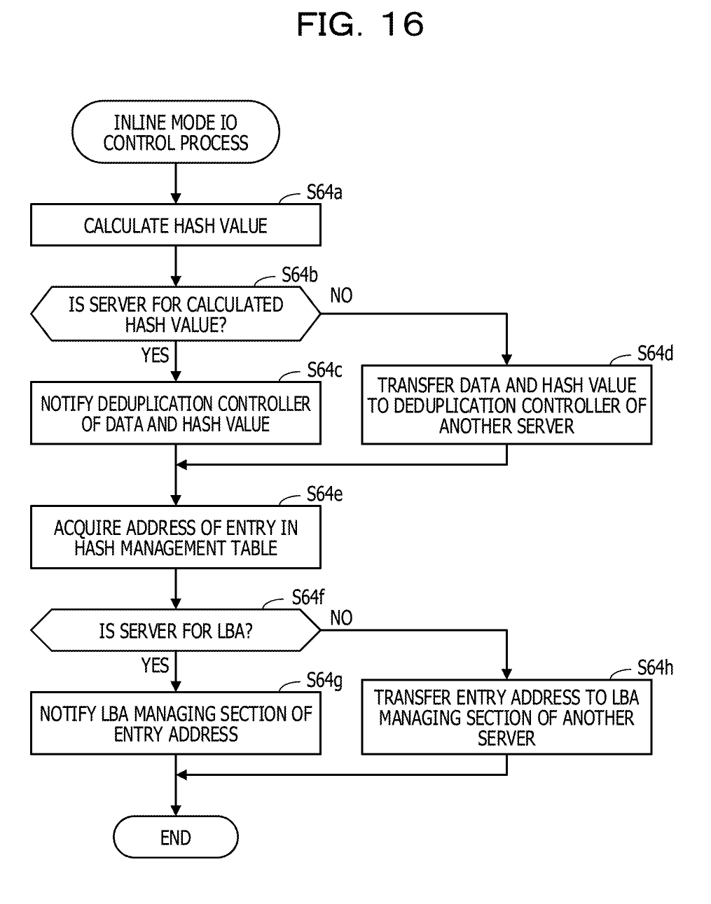

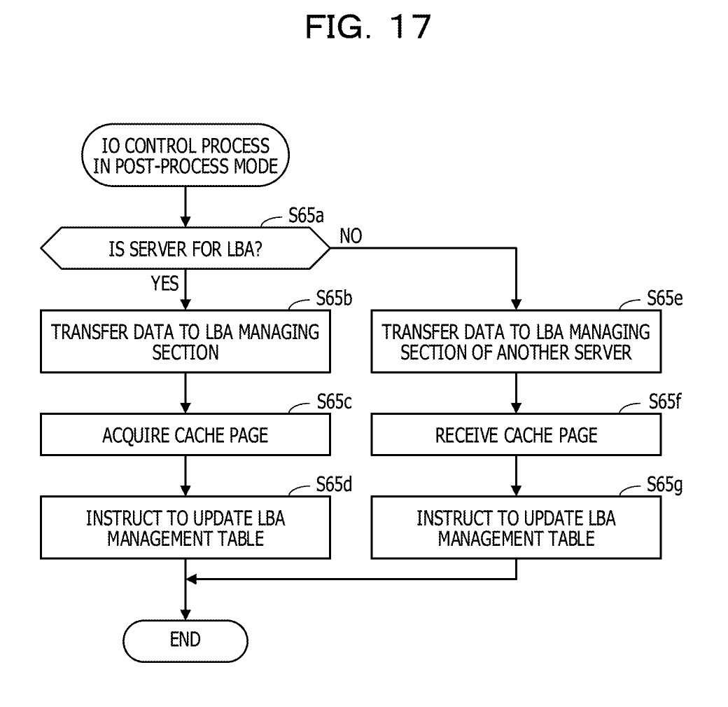

Next, the process of the server 100 is described using a flowchart. FIG. 14 is a flowchart illustrating a procedure example of the write response process.

[Step S61] The IO controller 131 receives a write request with an LBA of the logical volume specified as the write destination and data to be written from the host apparatus 400.

[Step S62] The IO controller 131 inquires of the mode determining section 132 which of the inline mode and post-process mode is to be selected as the write control mode. In response to the inquiry, the mode determining section 132 determines the write control mode to be selected. The details of the mode determination process by the mode determining section 132 are described in FIG. 15 next.

[Step S63] When the inline mode is selected as the result of the inquiry, the IO controller 131 executes the process of step S64, and when the post-process mode is selected, the IO controller 131 executes the process of step S65.

[Step S64] The IO controller 131 executes an IO control process in the inline mode. The details of the IO control process are described in FIG. 16 later.

[Step S65] The IO controller 131 executes the IO control process in the post-process mode. The details of the IO control process are described in FIG. 17 later.

[Step S66] When the process of the step S64 or S65 is completed, the IO controller 131 transmits a response message indicating completion of write to the host apparatus 400.

FIG. 15 is a flowchart illustrating a procedure example of the mode determination process. The process in FIG. 15 is executed by the mode determining section 132 in response to the inquiry from the IO controller 131 in the step S62 of FIG. 14.

[Step S62a] The parameter acquiring section 132a of the mode determining section 132 acquires the current numbers of hash uncalculated blocks and hash calculated blocks in the cache 110. These numbers are obtained by reading the hash uncalculated block count 123 and the hash calculated block count 124 from the storage section 120.

[Step S62b] The parameter evaluating section 132b of the mode determining section 132 calculates the ratio F_{det}/1-F_{det} of the number of hash uncalculated blocks to the number of hash calculated blocks. The parameter evaluating section 132b calculates the used page count c, which indicates the total number of cache pages currently used in the cache 110. The used page count c is calculated by adding up the hash uncalculated block count 123 and hash calculated block count 124.

[Step S62c] The parameter acquiring section 132a detects the storage instruction interval w of the storage 200. As described above, the storage instruction interval w indicates an interval in which a command instructing the SSD of the storage 200 to store data of one block is able to be transmitted. The storage 200 herein is the storage 200 belonging to the same storage node as the mode determining section 132.

[Step S62d] The parameter evaluating section 132b calculates the target ratio F_{tgt} of the number of hash uncalculated blocks to the number of hash calculated blocks.

In the second embodiment, the performance target S, hash value calculation time h, command transmission interval I, data transfer time t are previously recorded in the target information 125. The parameter evaluating section 132b calculates the aforementioned costs L and H based on the hash value calculation time h, command transmission interval I, and data transfer time t which are acquired from the target information 125 and the storage instruction interval w detected in the step S62c. Based on the calculated costs L and H and the performance target S acquired from the target information 125, the parameter evaluating section 132b calculates the target ratio F_{tgt} according to the aforementioned formula (2) and overwrites the target ratio F_{tgt} in the target information 125 of the storage section 120.

[Step S62e] The parameter evaluating section 132b determines whether the used page count c calculated in the step S62b is smaller than the product of the maximum number N of cache pages in the cache 110 and the target ratio F_{tgt} calculated in the step S62d. When the used page count c is smaller than the product, the parameter evaluating section 132b executes the process of step S62f. When the used page count c is not smaller than the product, the parameter evaluating section 132b executes the process of step S62g.

[Step S62f] When the used page count c is smaller than the product, it is estimated that the cache 110 has enough free space. In this case, an increase in the hash uncalculated blocks in the cache 110 will not influence the IOPS. The parameter evaluating section 132b sets the write control mode to be selected to the post-process mode.

[Step S62g] The parameter evaluating section 132b determines whether the used page count c is substantially equal to the maximum number N of cache pages. The used page count c is determined to be substantially equal to the maximum number N of cache pages when the difference between the used page count c and the maximum number N of cache pages is less than 1%, for example. When the used page count c is substantially equal to the maximum number N of cache pages, the parameter evaluating section 132b executes the process of step S62h. When the used page count c is not substantially equal to the maximum number N of cache pages, the parameter evaluating section 132b executes the process of step S62i.

[Step S62h] The case where the used page count c is substantially equal to the maximum number N of cache pages corresponds to the case where the cache 110 is substantially full. In this case, the time taken to destage the data stored in the cache 110 influences the response time for the write request of the host apparatus 400. Accordingly, selecting the post-process mode, which could produce hash uncalculated blocks that request much time to be destaged, is undesirable. The parameter evaluating section 132b therefore sets the write control mode to be selected to the inline mode.

[Step S62i] The parameter evaluating section 132b determines the write control mode to be selected based on the result of comparison between the target ratio F_{tgt} and the current ratio F_{det}. In this process, the write control mode is determined so that the ratio F_{det} approaches the target ratio F_{tgt}.

For example, when the ratio F_{det} is larger than the target ratio F_{tgt}, the parameter evaluating section 132b sets the write control mode to the inline mode, so that the number of hash uncalculated blocks is reduced. This increases the likelihood of reduction in the number of communications between servers in the background process in the post-process mode, and suppressing of the decreasing of the IOPS. On the other hand, when the ratio F_{det} is not larger than the target ratio F_{tgt}, the parameter evaluating section 132b sets the write control mode to the post-process mode. This may shorten the time taken to respond to the host apparatus 400 which has made the write request.

As another method, the parameter evaluating section 132b may be configured to control selection probability of the write control mode which is determined in the step S62i so that the probability of the post-process mode being selected approaches the target ratio F_{tgt}. For example, the parameter evaluating section 132b calculates the selection probability of the post-process mode that satisfies Formula (3) below. The calculated selection probability is indicated by a selection probability Fₛₑₗ. The selection probability Fₛₑₗ is limited to the range from 0 to 1.

Fₛₑₗ:1-Fₛₑₗ=F_{tgt}+(F_{tgt}-F_{det}):1-F_{tgt}+{1-F_{tgt}−(1-F_{det})} (3)

The parameter evaluating section 132b controls the selection probability of the write control mode which is determined in the step S62i so that the probability of the post-process mode being selected equal to the aforementioned selection probability Fₛₑₗ. For example, the parameter evaluating section 132b selects the post-process mode and the inline mode at a ratio of Fₛₑₗ:(1-Fₛₑₗ) for current and following successive data blocks requested by the host apparatus 400 to be written.

According to the aforementioned processes in FIGS. 14 and 15, when the cache 110 includes enough free space at the time of receiving a write request of the host apparatus 400, the write control process in the post-process mode is executed independently of the detected ratio F_{det}. This shortens the time taken to respond to the host apparatus 400. On the other hand, when the cache 110 includes no free space, the write control process in the inline mode is executed independently of the detected ratio F_{det}. This reduces a decrease in the IOPS.

Moreover, when the cache 110 includes free space to some extent, the ratio of the number of executions of the write control process in the post-process mode to that in the inline mode is controlled so as to approach the target ratio F_{tgt}. The write control of the post-process mode is therefore preferentially performed so that the IOPS is maintained at the target value or more. This minimizes the time taken to respond to the host apparatus 400 while maintaining the IOPS at the target value or more.

The process of FIG. 15 may be executed by the mode determining section 132 at regular time intervals, for example, in parallel to the process of FIG. 14 instead of being executed each time a write request is received from the host apparatus 400. In this case, the determined write control mode is registered in the storage section 120 and is referred to by the IO controller 131 in the step S62 of FIG. 14.

FIG. 16 is a flowchart illustrating a procedure example of the IO control process in the inline mode. The process of FIG. 16 corresponds to the process of the step S64 of FIG. 14.

[Step S64a] The IO controller 131 calculates the hash value of data to be written. The hash value is calculated using a hash function of secure hash algorithm 1 (SHA-1), for example.

[Step S64b] The IO controller 131 specifies the server for the calculated hash value based on the hash MSD value of the calculated hash value and determines whether the server 100 including the IO controller 131 is the server for the calculated hash value. When the server 100 is the server for the calculated hash value, the IO controller 131 executes the process of step S64c. When the server 100 is not the server for the calculated hash value, the IO controller 131 executes the process of step S64d.

[Step S64c] The IO controller 131 notifies the deduplication controller 133 of the server 100 including the IO controller 131 of the data to be written and the hash value and instructs the deduplication controller 133 to write the data to be written.

[Step S64d] The IO controller 131 transfers the data to be written and the hash value to the deduplication controller 133 of another server 100 as the server for the calculated hash value and instructs the same deduplication controller 133 to write the data to be written.

[Step S64e] The IO controller 131 acquires the address of the entry in the hash management table 121 from the notification destination in the step S64c or the transfer destination in the step S64d.

[Step 564f] Based on the LBA specified as the write destination of the data to be written, the IO controller 131 specifies the server for the LBA and determines whether the server 100 including the same IO controller 131 is the server for the specified LBA. When the server 100 is the server for the LBA, the IO controller 131 executes the process of step S64g. When the same server 100 is not the server for the LBA, the IO controller 131 executes the process of step S64h.

[Step S64g] The IO controller 131 notifies the LBA managing section 134 of the server 100 including the same IO controller 131 of the entry's address acquired in the step S64e and the LBA specified as the write destination and instructs the LBA managing section 134 to update the LBA management table 122.

[Step S64h] The IO controller 131 transfers the entry's address acquired in the step S64e and the LBA specified as the write destination to the LBA managing section 134 of another server 100 which is the server for the specified LBA and instructs the same LBA managing section 134 to update the LBA management table 122.

FIG. 17 is a flowchart illustrating a procedure example of the IO control process in the post-process mode. The process in FIG. 17 corresponds to the process of the step S65 in FIG. 14.

[Step S65a] Based on the LBA specified as the write destination of the data to be written, the IO controller 131 specifies the server for the specified LBA and determines whether the server 100 including the IO controller 131 is the server for the specified LBA. When the server 100 is the server for the specified LBA, the IO controller 131 executes the process of step S65b. When the server 100 is not the server for the specified LBA, the IO controller 131 executes the process of step S65e.

[Step S65b] The IO controller 131 notifies the LBA managing section 134 of the server 100 including the IO controller 131 of data to be written and instructs the LBA managing section 134 to store the data to be written in the cache 110.

[Step S65c] The IO controller 131 acquires the page number of the cache page storing the data to be written from the LBA managing section 134 notified in the step S65b.

[Step S65d] The IO controller 131 notifies the LBA managing section 134 of the server 100 including the same IO controller 131 of the acquired page number and the LBA specified as the write destination and instructs the LBA managing section 134 to update the LBA management table 122.

[Step S65e] The IO controller 131 transfers the data to be written to the LBA managing section 134 of another server 100 which is the server for the specified LBA and instructs the LBA managing section 134 to store the data to be written in the cache 110.

[Step S65f] The IO controller 131 receives the page number of the cache page storing the data to be written from the LBA managing section 134 as the transfer destination in the step S65e.

[Step S65g] The IO controller 131 transfers the acquired page number and the LBA specified as the write destination to the LBA managing section 134 of another server 100 which is the server for the specified LBA and instructs the LBA managing section 134 to update the LBA management table 122.

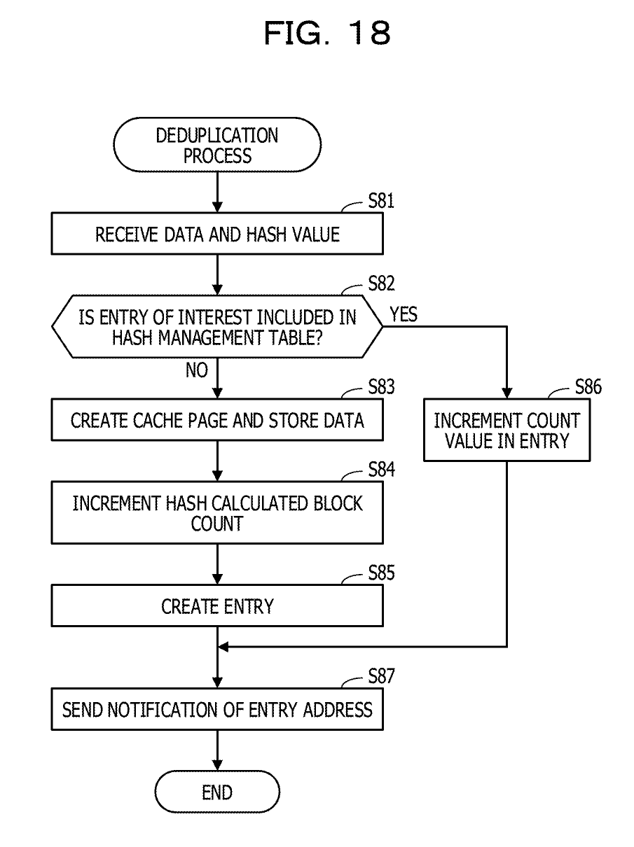

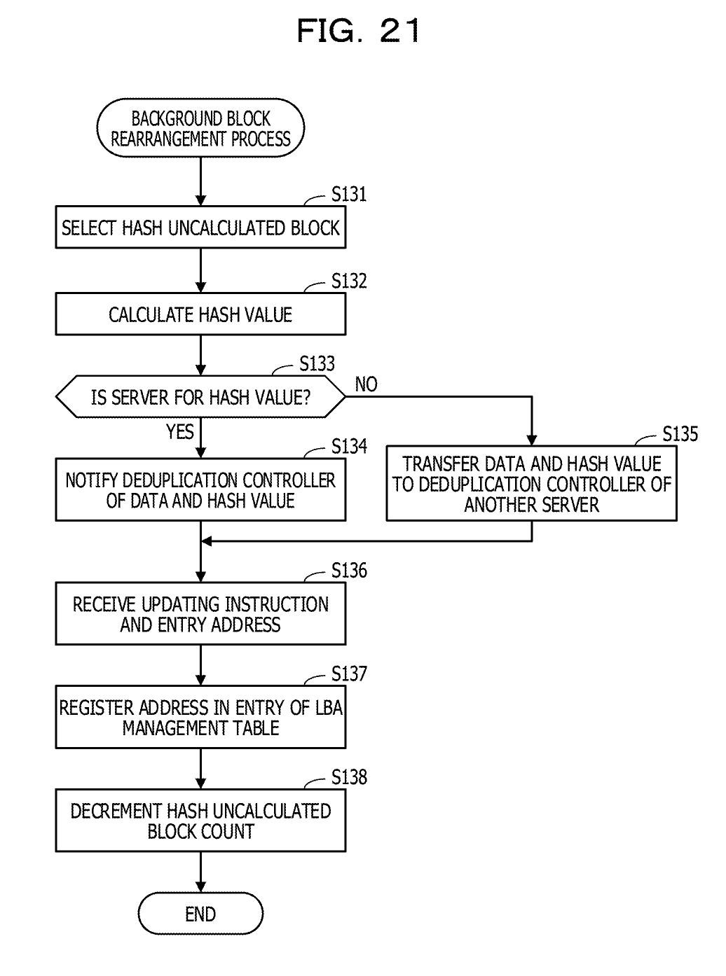

FIG. 18 is a flowchart illustrating a procedure example of the deduplication process.

[Step S81] The deduplication controller 133 receives data to be written and the hash value together with an instruction to write. For example, the deduplication controller 133 receives an instruction to write from the IO controller 131 of any server 100 in response to the steps S64c or S64d of FIG. 16. Alternatively, the deduplication controller 133 receives an instruction to write from the IO controller 131 of any server 100 in response to steps S134 or S135 of FIG. 21 described later.

[Step S82] The deduplication controller 133 determines whether the hash management table 121 includes an entry including the received hash value. When the hash management table 121 includes an entry including the received hash value, the deduplication controller 133 executes the process of step S86. When the hash management table 121 does not include any entry including the received hash value, the deduplication controller 133 executes the process of step S83.

[Step S83] When it is determined in the step S82 that the hash management table 121 does not include any entry including the received hash value, data with the same contents as the received data to be written is not stored yet in the cache 110 or storage 200. In this case, the deduplication controller 133 creates a new cache page in the cache 110 and stores the data to be written in the cache page. The data to be written is stored in the cache 110 as data of a hash calculated block.

[Step S84] The deduplication controller 133 increments the hash calculated block count 124 of the storage section 120.

[Step S85] The deduplication controller 133 creates a new entry in the hash management table 121. In the created entry, the deduplication controller 133 registers the received hash value in the hash value field; the page number of the cache page storing the data to be written in the step S83, in the pointer field; and 1, in the count value field.

[Step S86] When it is determined in the step S82 that the hash management table 121 already includes an entry including the received hash value, data with the same contents as the received data to be written is already stored in the cache 110 or storage 200. In this case, the deduplication controller 133 specifies the entry which includes the hash value received in the step S81, in the hash management table 121. The deduplication controller 133 increments the value in the count value field of the specified entry. The deduplication controller 133 discards the data to be written and hash value received in the step S81. By the process of the step S86, the data to be written is stored in the storage node without producing duplicates.

[Step S87] The deduplication controller 133 makes a notification of the address of the entry created in the step S85 or the entry specified in the step S86. When receiving an instruction to write from the IO controller 131 or LBA managing section 134 included in the same server 100 as the deduplication controller 133 in the step S81, the deduplication controller 133 notifies the IO controller 131 or LBA managing section 134 of the same server 100 of the entry's address. When receiving an instruction to write from the IO controller 131 or LBA managing section 134 included in a different server 100 from the deduplication controller 133 in the step S81, the deduplication controller 133 transfers the entry's address to the IO controller 131 or LBA managing section 134 included in the different server 100.

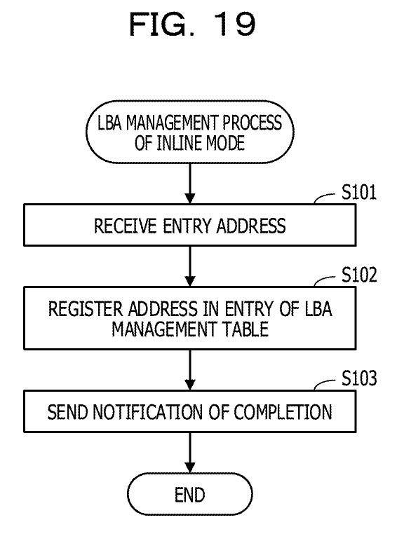

FIG. 19 illustrates a procedure example of the LBA management process of the inline mode.

[Step S101] The LBA managing section 134 receives the address of the entry in the hash management table 121 and the LBA specified as the write destination of the data to be written together with a table updating instruction. For example, the LBA managing section 134 receives the table updating instruction from the IO controller 131 of any server 100 in response to the process of the step S64g or S64h in FIG. 16.

[Step S102] The LBA managing section 134 specifies an entry including the LBA received in the step S101 from the LBA management table 122. The LBA managing section 134 registers the entry's address received in the step S101 in the pointer field of the specified entry.

[Step S103] The LBA managing section 134 transmits a message indicating completion of table updating, to the IO controller 131 which has transmitted the table updating instruction.

By the above-described process of FIG. 19, the LBA and the entry in the hash management table 121 are mapped for data of hash calculated blocks.

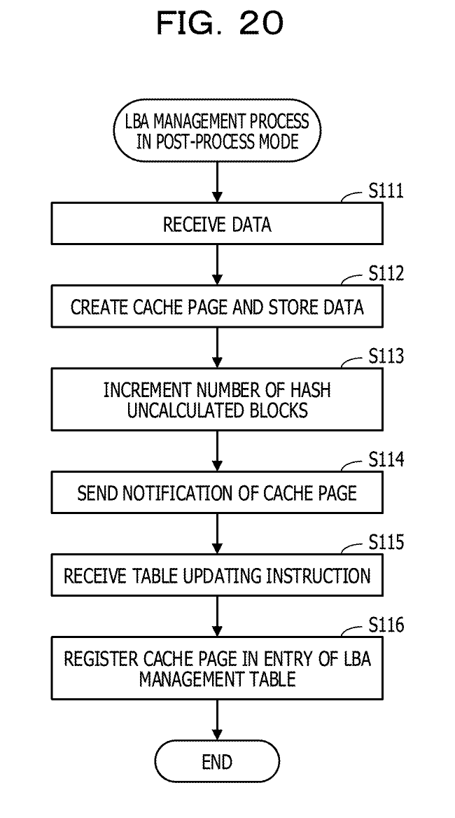

FIG. 20 illustrates a procedure example of the LBA management process of the post-process mode.

[Step S111] The LBA managing section 134 receives an instruction to store the data to be written in the cache 110. For example, the LBA managing section 134 receives an instruction to store the data to be written from the IO controller 131 of any server 100 in response to the process of the step S65b or S65e of FIG. 17.

[Step S112] The LBA managing section 134 creates a new cache page in the cache 110 and stores the data to be written in the created cache page. The data to be written is stored in the cache 110 as data of a hash uncalculated block.

[Step S113] The LBA managing section 134 increments the hash uncalculated block count 123 of the storage section 120.

[Step S114] The LBA managing section 134 notifies the IO controller 131 which has made the instruction to store the data to be written, of the page number of the cache page created in the step S112.

[Step S115] The LBA managing section 134 receives the page number of the cache page and the LBA specified as the write destination of the data to be written together with a table updating instruction. For example, the LBA managing section 134 receives the table updating instruction from the IO controller 131 of any server 100 in response to the process of the step S65d or 65g in FIG. 17.

[Step S116] The LBA managing section 134 specifies an entry including the LBA received in the step 115, in the LBA management table 122. The LBA managing section 134 registers the page number received in the step S115, in the pointer field of the specified entry.

The page number registered in the step S116 is the same as the page number in the step 114. The LBA managing section 134 may receive the LBA and the table updating instruction in the step S116 to update the LBA management table 122 by skipping the processes of the steps S114 and S115. The LBA managing section 134 may receive the LBA in the step S111.

By the above-described process of FIG. 20, the LBA and cache page are mapped for data of a hash uncalculated block.

FIG. 21 is a flowchart illustrating a procedure example of the block rearrangement process in the background. The process in FIG. 21 is executed in parallel to the write control process between reception of a write request and response to the write request, which is illustrated in FIGS. 14 to 20, asynchronously with the write control process.

[Step S131] The LBA managing section 134 selects data of a hash uncalculated block stored in the cache 110. For example, among the entries in the LBA management table 122, the LBA managing section 134 specifies entries in which the page number of any cache page is registered in the pointer fields. Among the specified entries, the LBA managing section 134 selects an entry with the earliest registration time of the page number or an entry which is accessed by the host apparatus 400 the least often. The data stored in the cache page indicated by the page number registered in the selected entry is to be selected as data of a hash uncalculated block.

[Step S132] The LBA managing section 134 calculates the hash value based on the data of the selected hash uncalculated block.

[Step S133] Based on the hash MSD value of the calculated hash value, the LBA managing section 134 specifies the server for the calculated hash value and determines whether the server 100 including the same LBA managing section 134 is the server for the calculated hash value. When the server including the LBA managing section 134 is the server for the calculated hash value, the LBA managing section 134 executes the process in step S134. When the server including the LBA managing section 134 is not the server for the calculated hash value, the LBA managing section 134 executes the process in step S135.

[Step S134] The LBA managing section 134 notifies the deduplication controller 133 of the server 100 including the LBA managing section 134 of the hash uncalculated block data and hash value and instructs the same deduplication controller 133 to write the data to be written.

[Step S135] The LBA managing section 134 transfers the data to be written and hash value to the deduplication controller 133 of another server 100 as the server for the calculated hash value and instructs the same deduplication controller 133 to write the data to be written.

[Step S136] The LBA managing section 134 receives the address of the entry in the hash management table 121 from the LBA managing section 134 notified of the data and hash value in the step S134 or the LBA managing section 134 to which the data and hash value are transferred in the step S135, together with the table updating instruction. The above entry is the entry corresponding to the hash value calculated in the step 132 and holds the position information of the physical storage area in which the hash uncalculated block selected in the step S131 is registered as a hash calculated block.

[Step S137] Among the entries of the LBA management table 122, the LBA managing section 134 specifies the entry corresponding to the data of the hash uncalculated block selected in the step S131. The LBA managing section 134 writes and registers the entry's address received in the step S136, in the pointer field of the specified entry.

[Step S138] The LBA managing section 134 decrements the hash uncalculated block count 123 of the storage section 120.

By the above-described process in FIG. 21, the data of hash uncalculated blocks is rearranged in the cache 110 of any server 100 with duplicate data removed.

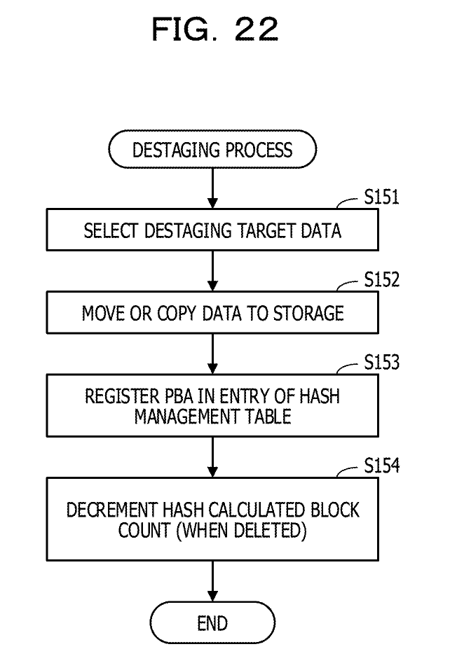

FIG. 22 is a flowchart illustrating a procedure example of the destaging process. The process in FIG. 22 is executed in parallel to the write control process illustrated in FIGS. 14 to 20 and the block rearrangement process in FIG. 21.

[Step S151] The IO controller 131 selects data to be destaged from the data of the hash calculated blocks stored in the cache 110. For example, when the cache 110 has little free space left, the IO controller 131 selects as a destaging target, data with the oldest last access time among data of hash calculated blocks stored in the cache 110. In this case, data as the destaging target is data to be deleted from the cache 110. The IO controller 131 may specify dirty data which is not synchronized with data in the storage 200 among data of hash calculated blocks stored in the cache 110. In this case, the IO controller 131 selects as the destaging target, data with the oldest update time among the specified dirty data, for example.

[Step S152] The IO controller 131 stores the selected data in the storage 200. When the selected data is to be deleted, the IO controller 131 moves the data from the cache 110 to the storage 200. When the selected data is not to be deleted, the IO controller 131 copies the data from the cache 110 to the storage 200.

[Step S153] The IO controller 131 specifies the entry corresponding to the data as the destaging target in the hash management table 121. For example, the IO controller 131 calculates the hash value of the selected data and specifies the entry in which the calculated hash value is registered in the hash management table 121. The IO controller 131 registers a physical block address (PBA) indicating the storage destination of the data in the step S152 in the pointer field of the specified entry.

[Step S154] The process is executed only when the selected data is a target to be deleted and is moved from the cache 110 in the step S152. The IO controller 131 decrements the hash calculated block count 124 of the storage section 120.

The processing functions of the apparatuses illustrated in each embodiment (the storage control apparatus 1, servers 100a to 100c, and host apparatuses 400a and 400b, for example) are implemented by a computer. In this case, programs describing the processes of the functions of each apparatus are provided. The aforementioned processing functions are implemented on a computer executing the provided programs. The program describing the processes may be recorded in a computer-readable recording medium. The computer-readable recording medium is a magnetic storage device, an optical disk, a magneto optical recording medium, a semiconductor memory, or the like. The magnetic storage device is a hard disk device (HDD), a flexible disk (FD), a magnetic tape, or the like. The optical disk is a digital versatile disk (DVD), a DVD-RAM, a compact disc-read only memory (CD-ROM), a CD-R (recordable)/RW (rewritable), or the like. The magneto optical recording medium is a magneto-optical (MO) disk or the like.

To distribute the program, a portable recording medium including the program, such as a DVD or a CD-ROM is sold, for example. Alternatively, the program may be stored in a storage device of a server computer to be transferred from the server computer to another computer through a network.

The computer configured to execute the program stores the program recorded in a portable recording medium or transferred from the server computer, in a storage device of the computer, for example. The computer reads the program from the storage device and executes a process in accordance with the program. The computer may read the program directly from a portable recording medium and execute the process in accordance with the program. Alternatively, the computer may execute a process in accordance with the program each time that the program is transferred.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. A storage control apparatus configured to control operation of a storage system including a plurality of storage nodes, each of the plurality of storage nodes including a storage device, the storage control apparatus comprising:
a memory; and
a processor coupled to the memory and configured to:
detect a ratio of a number of first data blocks stored by a first process to a number of second data blocks stored by a second process in data blocks stored in at least one of the storage devices included in the plurality of storage nodes, the first process including: from one of the plurality of storage nodes which has received a request to write a first write data block from a host apparatus, storing the first write data block in the storage device of any one of the plurality of storage nodes as one of the first data blocks after executing deduplication, and responding to the host apparatus with regard to the storing, the second process including: from one of the plurality of storage nodes which has received a request to write a second write data block from the host apparatus, storing the second write data block in the storage device of any one of the plurality of storage nodes as one of the second data blocks without executing the deduplication, and responding to the host apparatus with regard to the storing, and
determine which of the first and second processes to use to execute a write process for a third write data block which is newly requested to be written from the host apparatus so that the ratio approaches a target ratio based on a load of a third process for the second data blocks and a lower limit target value of a number of write requests processable per unit time in response to the write requests from the host apparatus, the third process including executing the deduplication for each of the second data blocks and storing again the second data block in the storage device of any one of the plurality of storage nodes.

2. The storage control apparatus according to claim 1, wherein
the storage device included in each of the plurality of storage nodes is a cache memory to cache data to be written in another storage device,
the target ratio is determined based on the load of the third process, a load of a fourth process for the first data blocks, and the lower limit target value,
the third process includes destaging each of the second data blocks to the another storage device, and
the fourth process includes destaging each of the first data blocks to the another storage device.

3. The storage control apparatus according to claim 2, wherein
the load of the third process represents an achievable time interval between successive executions of the third process,
the load of the fourth process represents an achievable time interval between successive executions of the fourth process, and
the target ratio is set to such a value that when the fourth and third processes are executed with the target ratio, a sum of numbers of executions of the fourth and third processes per unit time is not less than the lower limit target value and a number of executions of the third process is maximized.

4. The storage control apparatus according to claim 2, wherein
the third process includes instructing one of the plurality of storage nodes which is determined based on a logical address of a write destination of each of the second data blocks specified by the host apparatus, to map the logical address to information representing a storage area where the second data block is stored again.

5. The storage control apparatus according to claim 1, wherein
the first process includes:
calculating a first hash value based on the first write data block, and
executing the deduplication for and storing the first write data block as the first data block in the storage device of a first storage node determined based on the first hash value among the plurality of storage nodes,
the second process includes storing the second write data block as the second data block in the storage device of a second storage node determined based on a write destination of the second write data block among the plurality of storage nodes, and
the third process includes:
calculating a second hash value based on the second data block, and
executing the deduplication for and storing again the second data block in the storage device of a third storage node determined based on the second hash value among the plurality of storage nodes.

6. The storage control apparatus according to claim 1, wherein the processor is configured to:
determine to execute a write process for the third write data block using the second process when an amount of data stored in the storage devices of the plurality of storage nodes is less than a predetermined lower limit threshold.

7. The storage control apparatus according to claim 1, wherein the processor is configured to:
determine to execute a write process for the third write data block using the first process when an amount of data stored in the storage devices of the plurality of storage nodes is greater than a predetermined upper limited threshold.

8. A system comprising:
a plurality of storage nodes, each of the plurality of storage nodes including a storage device,
wherein at least one storage node of the plurality of storage nodes includes a processor configured to:
detect a ratio of a number of first data blocks stored by a first process to a number of second data blocks stored by a second process in data blocks stored in at least one of the storage devices included in the plurality of storage nodes, the first process including: from one of the plurality of storage nodes which has received a request to write a first write data block from a host apparatus, storing the first write data block in the storage device of any one of the plurality of storage nodes as one of the first data blocks after executing deduplication, and responding to the host apparatus with regard to the storing, the second process including: from one of the plurality of storage nodes which has received a request to write a second write data block from the host apparatus, storing the second write data block in the storage device of any one of the plurality of storage nodes as one of the second data blocks without executing the deduplication, and responding to the host apparatus with regard to the storing, and
determine which of the first and second processes to use to execute a write process for a third write data block which is newly requested to be written from the host apparatus so that the ratio approaches a target ratio based on a load of a third process for the second data blocks and a lower limit target value of a number of write requests processable per unit time in response to the write requests from the host apparatus, the third process including executing the deduplication for each of the second data blocks and storing again the second data block in the storage device of any one of the plurality of storage nodes.

9. The system according to claim 8, wherein
the storage device included in each of the plurality of storage nodes is a cache memory to cache data to be written in another storage device,
the target ratio is determined based on the load of the third process, a load of a fourth process for the first data blocks, and the lower limit target value,
the third process includes destaging each of the second data blocks to the another storage device, and
the fourth process includes destaging each of the first data blocks to the another storage device.

10. The system according to claim 9, wherein
the load of the third process represents an achievable time interval between successive executions of the third process,
the load of the fourth process represents an achievable time interval between successive executions of the fourth process, and
the target ratio is set to such a value that when the fourth and third processes are executed with the target ratio, a sum of numbers of executions of the fourth and third processes per unit time is not less than the lower limit target value and a number of executions of the third process is maximized.

11. The system according to claim 8, wherein
the first process includes:
calculating a first hash value based on the first write data block, and
executing the deduplication for and storing the first write data block as the first data block in the storage device of a first storage node determined based on the first hash value among the plurality of storage nodes,
the second process includes storing the second write data block as the second data block in the storage device of a second storage node determined based on a write destination of the second write data block among the plurality of storage nodes, and
the third process includes:
calculating a second hash value based on the second data block, and
executing the deduplication for and storing again the second data block in the storage device of a third storage node determined based on the second hash value among the plurality of storage nodes.

12. The system according to claim 8, wherein the processor is configured to:
determine to execute a write process for the third write data block using the second process when an amount of data stored in the storage devices of the plurality of storage nodes is less than a predetermined lower limit threshold.

13. The system according to claim 8, wherein the processor is configured to:
determine to execute a write process for the third write data block using the first process when an amount of data stored in the storage devices of the plurality of storage nodes is greater than a predetermined upper limited threshold.

14. A non-transitory storage medium storing a program causes a storage control apparatus configured to control operation of a storage system including a plurality of storage nodes each including a storage device to execute a process, the process comprising:
detecting a ratio of a number of first data blocks stored by a first process to a number of second data blocks stored by a second process in data blocks stored in at least one of the storage devices included in the plurality of storage nodes, the first process including: from one of the plurality of storage nodes which has received a request to write a first write data block from a host apparatus, storing the first write data block in the storage device of any one of the plurality of storage nodes as one of the first data blocks after executing deduplication, and responding to the host apparatus with regard to the storing, the second process including: from one of the plurality of storage nodes which has received a request to write a second write data block from the host apparatus, storing the second write data block in the storage device of any one of the plurality of storage nodes as one of the second data blocks without executing the deduplication, and responding to the host apparatus with regard to the storing; and
determining which of the first and second processes to use to execute a write process for a third write data block which is newly requested to be written from the host apparatus so that the ratio approaches a target ratio based on a load of a third process for the second data blocks and a lower limit target value of a number of write requests processable per unit time in response to the write requests from the host apparatus, the third process including executing the deduplication for each of the second data blocks and storing again the second data block in the storage device of any one of the plurality of storage nodes.

15. The storage medium according to claim 14, wherein
the storage device included in each of the plurality of storage nodes is a cache memory to cache data to be written in another storage device,
the target ratio is determined based on the load of the third process, a load of a fourth process for the first data blocks, and the lower limit target value,
the third process includes destaging each of the second data blocks to the another storage device, and
the fourth process includes destaging each of the first data blocks to the another storage device.

16. The storage medium according to claim 15, wherein
the load of the third process represents an achievable time interval between successive executions of the third process,
the load of the fourth process represents an achievable time interval between successive executions of the fourth process, and
the target ratio is set to such a value that when the fourth and third processes are executed with the target ratio, a sum of numbers of executions of the fourth and third processes per unit time is not less than the lower limit target value and a number of executions of the third process is maximized.

17. The storage medium according to claim 15, wherein
the third process includes instructing one of the plurality of storage nodes which is determined based on a logical address of a write destination of each of the second data blocks specified by the host apparatus, to map the logical address to information representing a storage area where the second data block is stored again.

18. The storage medium according to claim 14, wherein
the first process includes:
calculating a first hash value based on the first write data block, and
executing the deduplication for and storing the first write data block as the first data block in the storage device of a first storage node determined based on the first hash value among the plurality of storage nodes,
the second process includes storing the second write data block as the second data block in the storage device of a second storage node determined based on a write destination of the second write data block among the plurality of storage nodes, and
the third process includes:
calculating a second hash value based on the second data block, and
executing the deduplication for and storing again the second data block in the storage device of a third storage node determined based on the second hash value among the plurality of storage nodes.

19. The storage medium according to claim 14, wherein the process further comprises:
determining to execute a write process for the third write data block using the second process when an amount of data stored in the storage devices of the plurality of storage nodes is less than a predetermined lower limit threshold.

20. The storage medium according to claim 14, wherein the process further comprises:
determining to execute a write process for the third write data block using the first process when an amount of data stored in the storage devices of the plurality of storage nodes is greater than a predetermined upper limited threshold.
